(19) United States
(12) Patent Application Publication
(10) Pub. No.: US 2020/0097814 A1
(43) Pub. Date: Mar. 26, 2020

(54) METHOD AND SYSTEM FOR ENABLING INTERACTIVE DIALOGUE SESSION BETWEEN USER AND VIRTUAL MEDICAL ASSISTANT

(71) Applicant: MedWhat.com Inc., Spring Hill, FL (US)

(72) Inventor: Arturo DEVESA, Spring Hill, FL (US)

(21) Appl. No.: 16/143,389

(22) Filed: Sep. 26, 2018

(51) Int. Cl. G06N 3/08; G06F 17/30; G10L 15/18; G10L 15/22; G06F 17/27

(52) U.S. Cl. CPC G06N 3/08; G06F 17/30377; G06F 17/30864; G10L 15/1822; G06F 17/28; G10L 15/1815; G06F 17/2785; G06F 17/277; G10L 15/22

(57) ABSTRACT

A system for enabling an interactive dialogue session between a user and a virtual medical assistant system trains a virtual medical assistant system with a corpus of medical-training dataset. The system initializes a bi-directional conversation between the virtual medical assistant system and the user in real-time. The system also initializes a concept identification module to parse text present in the bi-directional conversation and retrieve specific concept from the bi-directional conversation. The system also maps the word embedding of the retrieved specific concept from the enquired question with the word embedding of words created from the corpus of medical-training dataset. The system also interactively replies to question by the user with the determined appropriate utterance as response with the associated confidence level. In addition, the system updates the corpus of medical-training dataset in real-time using recurrent neural networks.

### TECHNICAL FIELD

The present disclosure relates to the field of medical informatics, and in particular, to a method and system for enabling an interactive dialogue session between a user and a virtual medical assistant system based on deep learning.

### INTRODUCTION

Over the past few years, there is a massive amount of increase in usage of virtual assistants in our day to day life. In general, the virtual assistant is a software agent that can perform certain tasks or services for an individual. In an example, the virtual assistants are represented as chatbots. Further, the virtual assistants are based on technologies such as Artificial Intelligence, Machine Learning, Deep Learning, Neural Networks, and the like. The virtual assistants communicate with the user using text, image or voice commands. The virtual assistants interpret the queries of the user using technologies such as natural language processing, speech recognition etc. Further, the virtual assistants can perform actions such as setting up of an alarm, searching information on the Internet etc. Furthermore, the virtual assistants can be installed and run on devices such as computing devices, mobile devices, laptops, smart watches and the like. Further, the virtual assistants are capable enough to perform interactive dialogue with the user.

### SUMMARY

In a first example, a computer-implemented method is provided. The computer-implemented method enables an interactive dialogue session between a user and a virtual medical assistant system. The interactive dialogue session is enabled for providing medical assistance to the user. The computer-implemented method includes a first step of training a virtual medical assistant system with a corpus of medical-training dataset. The training of the virtual medical assistant system includes creating word embedding of words present in the corpus of medical-training dataset in a low dimensional vector space.

Further, the training of the virtual medical assistant system includes extracting a plurality of dialogue conversations from the corpus of the medical-training dataset based on the created word embedding. Furthermore, the training of the virtual medical assistant system includes prioritizing the plurality of extracted dialogue conversations based on the one or more medical protocols. The word embedding of words is created using one or more methods. The plurality of dialogue conversations are conversations between a plurality of users and a plurality of professional medical practitioners. The prioritization is done to train the virtual medical assistant system to learn an appropriate utterance to respond to the user from the corpus of medical-training dataset.

The computer-implemented method includes another step of initializing a bi-directional conversation between the virtual medical assistant system and the user through a computing device in real-time. The computer-implemented method includes yet another step of initializing a concept identification module to parse text present in the bi-directional conversation and retrieve specific concept from the bi-directional conversation. The computer-implemented method includes yet another step of mapping the word embedding of the retrieved specific concept from the enquired question with the word embedding of words created from the corpus of medical-training dataset. The computer-implemented method includes yet another step of interactively replying by the virtual medical assistant system to the enquired question by the user with the determined appropriate utterance as response with the associated confidence level.

The computer-implemented method further includes yet another step of updating a health profile of the user and the corpus of the medical-training dataset in real-time using recurrent neural networks. The virtual medical assistant system is trained based on one or more medical protocols. The virtual medical assistant system is trained with the corpus of medical-training dataset in a plurality of input forms. The bi-directional conversation is initialized by enquiring a question by the user or the virtual medical assistant system. The bi-directional conversation is initialized to facilitate the virtual medical assistant system to provide medical assistance to the user.

The concept identification module is initialized to identify context of the bi-directional conversation. The concept identification module is initialized to determine if the specific concept match with the one or more medical protocols. The retrieved specific concept is represented as word embedding in the low dimensional vector space representation by the virtual medical assistant system. The mapping is done to determine the appropriate utterance as response to the enquired question in context of the bi-directional conversation. The context is concatenation of the enquired question as well as past utterances by the user and the virtual medical assistant system.

The mapping is done to determine the appropriate utterance as response even when the word embedding of the retrieved specific concept from the enquired question is not present in the word embedding of words created from the corpus of medical-training dataset using deep learning. The appropriate utterance as response is determined with an associated confidence level. The mapping is done based on a plurality of deep learning algorithms and neural network models. The virtual medical assistant system interactively replies to the enquired question in a plurality of output forms. The updating is done based on the enquired question from the user that is not present in the word embedding of words created from the corpus of the medical-training dataset. The bi-directional conversation is continued until the user is provided complete medical assistance by the virtual medical assistance system.

In an embodiment of the present disclosure, the corpus of medical-training dataset includes a plurality of question-answer pairs, a plurality of medical questions, a plurality of medical articles and a plurality of medical conversations. The corpus of medical-training dataset is created from one or more sources. The one or more sources include medical literature, textbooks, online databases, journal articles, graphics, podcasts, videos, animations and medical data warehouses. The plurality of input forms includes at least one of text, image, audio, video, gif and animation.

In an embodiment of the present disclosure, the training of the virtual medical assistant system facilitates learning of the virtual medical assistant system. The learning of the virtual medical assistant system includes crawling the corpus of medical-training dataset to obtain the plurality of the dialogue conversations from the corpus of medical-training dataset. Further, the learning of the virtual medical assistant system includes manual annotation of questions based on a plurality of criteria. Furthermore, the learning of the virtual medical assistant system includes building automatic classifiers for prioritizing the plurality of dialogue conversations. The plurality of criteria includes user feedback, new content sources and popular questions. The manual annotation of questions is followed by binary annotation of the dialogue conversations. The automatic classifiers are build using a plurality of hardware-run machine learning algorithms. The plurality of hardware-run machine learning algorithms includes Random Forest, Adaboost, Naive Bayes and Support Vector Machine algorithm.

In an embodiment of the present disclosure, the one or more medical protocols are guidelines from one or more recognized medical institutions to provide medical assistance to the user.

In an embodiment of the present disclosure, the one or more methods used to create the word embedding comprise of recurrent neural networks, convolutional neural networks, word embedding layer, word2vec and glove algorithms.

In an embodiment of the present disclosure, plural dialogue conversations are extracted from the corpus of medical-training dataset using natural language processing algorithms and speech recognition algorithms.

In an embodiment of the present disclosure, the plurality of dialogue conversations extracted manually is prioritized based on a confidence score. The confidence score determines amount of confidence in a plurality of answers for the plurality of questions in the plurality of dialogue conversations.

In an embodiment of the present disclosure, the bi-directional conversation is initialized with the virtual medical assistant system in the plurality of input forms. The virtual medical assistant system retrieves the specific concept from the bi-directional conversation using the natural language processing algorithms and the speech recognition algorithms.

In an embodiment of the present disclosure, the virtual medical assistant system tokenizes the context and utterances present in the word embedding of words created from the corpus of medical-training dataset and the word embedding of the retrieved specific concept from the enquired question. The virtual medical assistant system tokenizes the context and utterances to insert special delineation tokens between the context and utterances to distinguish between the virtual medical assistant system and the user.

In an embodiment of the present disclosure, the mapping of the word embedding of the retrieved specific concept from the enquired question with the word embedding of words created from the corpus of medical-training dataset includes mapping the enquired question from the user with the questions present in the plurality of dialogue conversations based on the context of the bi-directional conversation using unsupervised deep learning algorithms. In addition, the mapping of the word embedding of the retrieved specific concept from the enquired question with the word embedding of words created from the corpus of medical-training dataset includes mapping the enquired question from the user with answers present in the plurality of dialogue conversations based on the context of the bi-directional conversation using supervised deep learning algorithms.

In an embodiment of the present disclosure, the plurality of output forms include at least one of text, image, audio, video, gif and animation.

In an embodiment of the present disclosure, the virtual medical assistant system is trained using embedding functions. The virtual medical assistant system utilizes embedding functions for embedding context pairs. The virtual medical assistant system utilizes embedding functions for embedding and utterance pairs.

In an embodiment of the present disclosure, the virtual medical assistant system determines medical issue faced by the user. The virtual medical assistant system determines the medical issue by checking for symptoms of diseases by retrieval of specific concepts from the bi-directional conversation initialized between the user and the virtual medical assistant system.

In an embodiment of the present disclosure, the virtual medical assistant system determines health status of the user. The virtual medical assistant determines the health status of the user based on one or more health related devices connected with the virtual medical assistant system. The virtual medical assistant system determines the health status of the user based on the interaction history of the user with the virtual medical assistant system.

In an embodiment of the present disclosure, the virtual medical assistant system is connected with one or more health related devices associated with the user. The virtual medical assistant system fetches a set of data associated with health status of the user from the one or more connected health related devices. The set of data fetched is stored in the health profile associated with the user.

In a second example, a computer system is provided. The computer system includes one or more processors, and a memory. The memory is coupled to the one or more processors. The memory stores instructions. The memory is executed by the one or more processors. The execution of the memory causes the one or more processors to perform a method for enabling an interactive dialogue session between a user and a virtual medical assistant system. The interactive dialogue session is enabled for providing medical assistance to the user. The method includes a first step of training a virtual medical assistant system with a corpus of medical-training dataset. The training of the virtual medical assistant system includes creating word embedding of words present in the corpus of medical-training dataset in a low dimensional vector space.

Further, the training of the virtual medical assistant system includes extracting a plurality of dialogue conversations from the corpus of the medical-training dataset based on the created word embedding. Furthermore, the training of the virtual medical assistant system includes prioritizing the plurality of extracted dialogue conversations based on the one or more medical protocols. The word embedding of words is created using one or more methods. The plural dialogue conversations are conversations between a plurality of users and a plurality of professional medical practitioners. The prioritization is done to train the virtual medical assistant system to learn an appropriate utterance to respond to the user from the corpus of medical-training dataset.

The method includes another step of initializing a bi-directional conversation between the virtual medical assistant system and the user through a computing device in real-time. The method includes yet another step of initializing a concept identification module to parse text present in the bi-directional conversation and retrieve specific concept from the bi-directional conversation. The method includes yet another step of mapping the word embedding of the retrieved specific concept from the enquired question with the word embedding of words created from the corpus of medical-training dataset.

The method further includes another step of interactively replying by the virtual medical assistant system to the enquired question by the user with the determined appropriate utterance as response with the associated confidence level. The method includes yet another step of updating a health profile of the user and the corpus of the medical-training dataset in real-time using recurrent neural networks.

The virtual medical assistant system is trained based on one or more medical protocols. The virtual medical assistant system is trained with the corpus of medical-training dataset in a plurality of input forms.

The bi-directional conversation is initialized by enquiring a question by the user or the virtual medical assistant system. The bi-directional conversation is initialized to facilitate the virtual medical assistant system to provide medical assistance to the user.

The concept identification module is initialized to identify context of the bi-directional conversation. The concept identification module is initialized to determine if the specific concept match with the one or more medical protocols. The retrieved specific concept is represented as word embedding in the low dimensional vector space representation by the virtual medical assistant system.

The mapping is done to determine the appropriate utterance as response to the enquired question in context of the bi-directional conversation. The context is concatenation of the enquired question as well as past utterances by the user and the virtual medical assistant system. The mapping is done to determine the appropriate utterance as response even when the word embedding of the retrieved specific concept from the enquired question is not present in the word embedding of words created from the corpus of medical-training dataset using deep learning. The appropriate utterance as response is determined with an associated confidence level. The mapping is done based on a plurality of deep learning algorithms and neural network models. The virtual medical assistant system interactively replies to the enquired question in a plurality of output forms.

The updating is done based on the enquired question from the user that is not present in the word embedding of words created from the corpus of the medical-training dataset. The bi-directional conversation is continued until the user is provided complete medical assistance by the virtual medical assistance system.

In an embodiment of the present disclosure, the corpus of medical-training dataset includes a plurality of question-answer pairs, a plurality of medical questions, a plurality of medical articles and a plurality of medical conversations. The corpus of medical-training dataset is created from medical literature, textbooks, online databases, journal articles, graphics, podcasts, videos, animations and medical data warehouses. The plurality of input forms includes at least one of text, image, audio, video, gif and animation.

In an embodiment of the present disclosure, the training of the virtual medical assistant system facilitates learning of the virtual medical assistant system. The learning of the virtual medical assistant system includes crawling the corpus of medical-training dataset to obtain the plurality of the dialogue conversations from the corpus of medical-training dataset. Further, the learning of the virtual medical assistant system includes manual annotation of questions based on a plurality of criteria. Furthermore, the learning of the virtual medical assistant system includes building automatic classifiers for prioritizing the plurality of dialogue conversations. The plurality of criteria includes user feedback, new content sources and popular questions. The manual annotation of questions is followed by binary annotation of the dialogue conversations. The automatic classifiers are build using a plurality of hardware-run machine learning algorithms. The plurality of hardware-run machine learning algorithms includes Random Forest, Adaboost, Naive Bayes and Support Vector Machine algorithm.

In an embodiment of the present disclosure, the mapping of the word embedding of the retrieved specific concept from the enquired question with the word embedding of words created from the corpus of medical-training dataset includes mapping the enquired question from the user with the questions present in the plurality of dialogue conversations based on the context of the bi-directional conversation using unsupervised deep learning algorithms. In addition, the mapping of the word embedding of the retrieved specific concept from the enquired question with the word embedding of words created from the corpus of medical-training dataset includes mapping the enquired question from the user with answers present in the plurality of dialogue conversations based on the context of the bi-directional conversation using supervised deep learning algorithms.

In a third example, a computer-readable storage medium is provided. The computer-readable storage medium encodes computer executable instructions that, when executed by at least one processor, performs a method. The method enables an interactive dialogue session between a user and a virtual medical assistant system. The interactive dialogue session is enabled for providing medical assistance to the user. The method includes a first step of training a virtual medical assistant system with a corpus of medical-training dataset. The training of the virtual medical assistant system includes creating word embedding of words present in the corpus of medical-training dataset in a low dimensional vector space. Further, the training of the virtual medical assistant system includes extracting a plurality of dialogue conversations from the corpus of the medical-training dataset based on the created word embedding.

Furthermore, the training of the virtual medical assistant system includes prioritizing the plurality of extracted dialogue conversations based on the one or more medical protocols. The word embedding of words is created using one or more methods. The plurality of dialogue conversations are conversations between a plurality of users and a plurality of professional medical practitioners. The prioritization is done to train the virtual medical assistant system to learn an appropriate utterance to respond to the user from the corpus of medical-training dataset.

The method includes another step of initializing a bi-directional conversation between the virtual medical assistant system and the user through a computing device in real-time. The method includes yet another step of initializing a concept identification module to parse text present in the bi-directional conversation and retrieve specific concept from the bi-directional conversation. The method includes yet another step of mapping the word embedding of the retrieved specific concept from the enquired question with the word embedding of words created from the corpus of medical-training dataset.

The method further includes another step of interactively replying by the virtual medical assistant system to the enquired question by the user with the determined appropriate utterance as response with the associated confidence level. The method includes yet another step of updating a health profile of the user and the corpus of the medical-training dataset in real-time using recurrent neural networks. The virtual medical assistant system is trained based on one or more medical protocols. The virtual medical assistant system is trained with the corpus of medical-training dataset in a plurality of input forms.

The bi-directional conversation is initialized by enquiring a question by the user or the virtual medical assistant system. The bi-directional conversation is initialized to facilitate the virtual medical assistant system to provide medical assistance to the user. The concept identification module is initialized to identify context of the bi-directional conversation. The concept identification module is initialized to determine if the specific concept match with the one or more medical protocols. The retrieved specific concept is represented as word embedding in the low dimensional vector space representation by the virtual medical assistant system.

The mapping is done to determine the appropriate utterance as response to the enquired question in context of the bi-directional conversation. The context is concatenation of the enquired question as well as past utterances by the user and the virtual medical assistant system. The mapping is done to determine the appropriate utterance as response even when the word embedding of the retrieved specific concept from the enquired question is not present in the word embedding of words created from the corpus of medical-training dataset using deep learning. The appropriate utterance as response is determined with an associated confidence level. The mapping is done based on a plurality of deep learning algorithms and neural network models. The virtual medical assistant system interactively replies to the enquired question in a plurality of output forms. The updating is done based on the enquired question from the user that are not present in the word embedding of words created from the corpus of the medical-training dataset. The bi-directional conversation is continued until the user is provided complete medical assistance by the virtual medical assistance system.

### BRIEF DESCRIPTION OF THE FIGURES

Having thus described the invention in general terms, references will now be made to the accompanying figures, wherein:

FIG. 1 illustrates a general overview of an interactive dialogue session between a user and a virtual medical assistant system through a computing device, in accordance with various embodiments of the present disclosure;

FIG. 2 illustrates an interactive computing environment for enabling the interactive dialogue session between the user and the virtual medical assistant system through the computing device, in accordance with various embodiments of the present disclosure;

FIG. 3 illustrates a block diagram of an example of RNN embedding model, in accordance with various embodiments of the present disclosure;

FIG. 4 illustrates a block diagram of an example for implementation of word embedding by the virtual medical assistant system, in accordance with various embodiments of the present disclosure;

FIG. 5 illustrates a block diagram for execution of learning of the virtual medical assistant system during training, in accordance with various embodiments of the present disclosure;

FIG. 6 illustrates a flow chart for depicting internal representation of the interactive dialogue session conducted between the virtual medical assistant system and the user, in accordance with various embodiments of the present disclosure;

FIG. 7 illustrates a block diagram of separate RNN's used for computation of margin loss to be minimized during training of the virtual medical assistant system, in accordance with various embodiments of the present disclosure;

FIG. 8 illustrates an internal representation of tokens and utterances during training of the virtual medical assistant system, in accordance with various embodiments of the present disclosure;

FIG. 9 illustrates a flow chart for depicting a method to provide appropriate utterance as response to an enquired question from the user to the virtual medical assistant system, in accordance with various embodiments of the present disclosure;

FIGS. 10A and 10B illustrate a flow chart for enabling the interactive dialogue session between the user and the virtual medical assistant system, in accordance with various embodiments of the present disclosure; and

FIG. 11 illustrates a block diagram of the device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

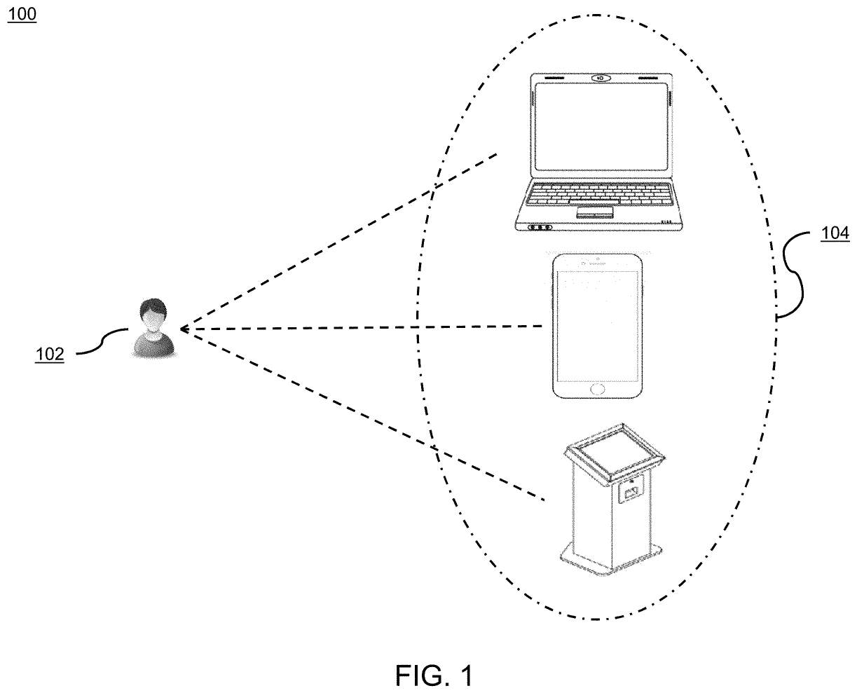

FIG. 1 illustrates a general overview 100 of an interactive dialogue session between a user 102 and a virtual medical assistant system through a computing device 104, in accordance with various embodiments of the present disclosure. The general overview 100 includes the user 102 and the computing device 104. In an embodiment of the present disclosure, the user 102 is any person who wants medical assistance from a professional person having medical knowledge. In another embodiment of the present disclosure, the user 102 is any person who wants medical assistance from a medical practitioner. In another embodiment of the present disclosure, the user 102 is any person suffering from some disease. In another embodiment of the present disclosure, the user 102 wants to seek medical attention from the professional or the medical practitioner. In yet another embodiment of the present disclosure, the user 102 is any person who wants medical assistance to cure sickness faced by the user 102 or some other friend or other user. In yet another embodiment of the present disclosure, the user 102 is any person who wants to know severity of the disease or sickness faced by the user 102. In yet another embodiment of the present disclosure, the user 102 requires general medical information to improve his/her knowledge regarding medical subject.

Further, the general overview 100 includes the computing device 104. The computing device 104 is associated with the user 102. In an embodiment of the present disclosure, the computing device 104 is a portable computing device 104. In an example, the portable computing device 104 includes laptop, smartphone, tablet, PDA and the like. In an example, the smartphone may be an Apple smartphone, an Android-based smartphone, a Windows-based smartphone and the like. In another embodiment of the present disclosure, the computing device 104 is a fixed computing device 104. In an example, the fixed computing device 104 includes a desktop, a workstation PC, a mainframe computer and the like. In yet another embodiment of the present disclosure, the computing device 104 is a kiosk installed at a medical facility. In general, the kiosk is a small, free-standing physical structure that displays information and provides a service. Further, the kiosk may be manned or unmanned.

In an embodiment of the present disclosure, the computing device 104 includes an advanced vision display panel. The advanced vision display panel includes OLED, AMOLED, Super AMOLED, Retina display, Haptic touchscreen display and the like. In another embodiment of the present disclosure, the computing device 104 includes a basic display panel. The basic display panel includes but may not be limited to LCD, IPS-LCD, capacitive touchscreen LCD, resistive touchscreen LCD, TFT-LCD and the like.

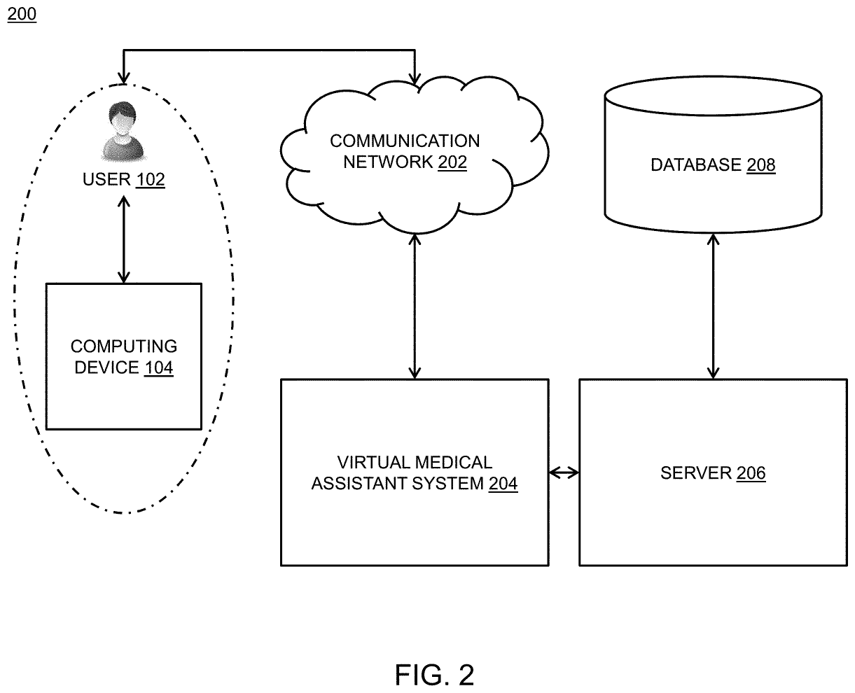

FIG. 2 illustrates an interactive computing environment 200 for enabling the interactive dialogue session between the user 102 and a virtual medical assistant system 204 through the computing device 104, in accordance with various embodiments of the present disclosure. The system includes the user 102, the computing device 104, a communication network 202, and the virtual medical assistant system 204. Further, the system includes a server 206, and a database 208.

The user 102 utilizes the computing device 104 to connect to the virtual medical assistant system 204. The computing device 104 is connected to the communication network 202. The communication network 202 provides medium to the computing device 104 to connect to the virtual medical assistant system 204. Also, the communication network 202 provides network connectivity to the computing device 104. In an example, the communication network 202 uses protocol to connect the computing device 104 to the virtual medical assistant system 204. The communication network 202 connects the computing device 104 to the virtual medical assistant system 204 using a plurality of methods. The plurality of methods used to provide network connectivity to the computing device 104 includes 2G, 3G, 4G, Wifi and the like.

In an embodiment of the present disclosure, the communication network 202 may be any type of network that provides internet connectivity to the computing device 104. In an embodiment of the present disclosure, the communication network 202 is a wireless mobile network. In another embodiment of the present disclosure, the communication network 202 is a wired network with a finite bandwidth. In yet another embodiment of the present disclosure, the communication network 202 is combination of the wireless and the wired network for optimum throughput of data transmission. In yet another embodiment of the present disclosure, the communication network 202 is an optical fiber high bandwidth network that enables high data rate with negligible connection drops.

In an embodiment of the present disclosure, the virtual medical assistant system 204 is installed inside the computing device 104. In an embodiment of the present disclosure, the computing device 104 connects with the virtual medical assistant system 204 by utilizing one or more applications. In general, the application is any software code that is basically programmed to interact with hardware elements of the computing system. The term hardware elements here refer to a plurality of memory types installed inside the computing device 104. Moreover, the application is used to access, read, update and modify data stored in hardware elements of the computing device 104. Also, the application provides a user interface to the user 102 to interact with hardware elements of the computing device 104. The user interface may include Graphical User Interface (GUI), Application Programming Interface (API), and the like. The user interface helps to send and receive user commands and data. In addition, the user interface serves to display or return results of operation from the application. In an embodiment of the present disclosure, the user interface is part of the application. In addition, the mobile application installed inside the computing device 104 may be based on any mobile platform. In an example, the mobile platform includes but may not be limited to Android, iOS, BlackBerry, Symbian, Windows and Bada. Further, the mobile application installed inside the computing device 104 runs on any version of respective mobile platform of the above mentioned mobile platforms.

In another embodiment of the present disclosure, the computing device 104 accesses the virtual medical assistant system 204 using a web-based interface. In an embodiment of the present disclosure, the virtual medical assistant system 204 is accessed through a web browser installed inside the computing device 104. In another embodiment of the present disclosure, the computing device 104 access the virtual medical assistant system 204 through a widget, API, web applets and the like. In an example, the web-browser includes but may not be limited to Opera, Mozilla Firefox, Google Chrome, Internet Explorer, Microsoft Edge, Safari and UC Browser. Further, the web browser installed on the computing device 104 runs on any version of the respective web browser of the above mentioned web browsers.

Further, the computing device 104 performs computing operations based on a suitable operating system installed inside the computing device 104. In general, the operating system is system software that manages computer hardware and software resources and provide common services for computer programs. In addition, the operating system acts as an interface for software installed inside the computing device 104 to interact with hardware components of the computing device 104. In an embodiment of the present disclosure, the operating system installed inside the computing device 104 is a mobile operating system. In an embodiment of the present disclosure, the computing device 104 performs computing operations based on any suitable operating system designed for portable computing device 104. In an example, the mobile operating system includes but may not be limited to Windows operating system from Microsoft, Android operating system from Google, iOS operating system from Apple, Symbian operating system from Nokia, Bada operating system from Samsung Electronics and BlackBerry operating system from BlackBerry. However, the operating system is not limited to above mentioned operating systems. In an embodiment of the present disclosure, the computing device 104 operates on any version of particular operating system of above mentioned operating systems.

In another embodiment of the present disclosure, the computing device 104 performs computing operations based on any suitable operating system designed for fixed computing device 104. In an example, the operating system installed inside the computing device 104 is Windows from Microsoft. In another example, the operating system installed inside the computing device 104 is Mac from Apple. In yet another example, the operating system installed inside the computing device 104 is Linux based operating system. In yet another example, the operating system installed inside the computing device 104 may be one of UNIX, Kali Linux, and the like. However, the operating system is not limited to above mentioned operating systems.

In an embodiment of the present disclosure, the computing device 104 operates on any version of Windows operating system. In another embodiment of the present disclosure, the computing device 104 operates on any version of Mac operating system. In another embodiment of the present disclosure, the computing device 104 operates on any version of Linux operating system. In yet another embodiment of the present disclosure, the computing device 104 operates on any version of particular operating system of the above mentioned operating systems.

In an embodiment of the present disclosure, the virtual medical assistant system 204 is installed at the server 206. In another embodiment of the present disclosure, the virtual medical assistant system 204 is installed at a plurality of servers. In an example, the plurality of servers may include database server, file server, application server and the like. The plurality of servers communicate with each other using the communication network 202. In general, the communication network 202 is part of network layer responsible for connection of two or more servers.

The user 102 utilizes the computing device 104 to enable the interactive dialogue session between the virtual medical assistant system 204 and the user 102. In general, the interactive dialogue session is a session in which communication takes place efficiently with computer system. The communication takes place so efficiently that it feels like as if communication is being conducted between two human users. The virtual medical assistant system 204 is initially trained with a corpus of medical-training dataset. In an embodiment of the present disclosure, the virtual medical assistant system 204 is trained by an administrator. In another embodiment of the present disclosure, the virtual medical assistant system 204 is trained by a person who knows how to operate the virtual medical assistant system 204. In yet another embodiment of the present disclosure, the virtual medical assistant system 204 is trained by one or more administrators.

The corpus of medical-training dataset includes a plurality of question-answer pairs, a plurality of medical questions, a plurality of medical articles, a plurality of medical conversations and the like. The corpus of medical-training dataset is created from one or more sources. Further, the one or more sources include medical literature, textbooks, online databases, journal articles, graphics, podcasts, videos, animations and medical data warehouses. Further, the virtual medical assistant system 204 is trained based on one or more medical protocols. The one or more medical protocols are guidelines from one or more recognized medical institutions to provide medical assistance to the user 102. In general, the medical protocols are guidelines or rules to be followed for proper treatment of a person. The virtual medical assistant system 204 is trained with the corpus of medical-training dataset in a plurality of input forms. The plurality of input forms comprise of at least one of text, image, audio, video, gif, animation, and the like.

In an embodiment of the present disclosure, the corpus of medical-training dataset includes the plurality of question-answer pairs. The plurality of question-answer pairs are extracted from the one or more sources. In an embodiment of the present disclosure, the plurality of questions of the plurality of question-answer pairs is generated by laypersons. In an embodiment of the present disclosure, the plurality of answers of the plurality of question-answer pairs is generated by the medical practitioners. In an embodiment of the present disclosure, the plurality of question-answer pairs is utilized as a reserve resource in the corpus of medical-training dataset.

In an embodiment of the present disclosure, the corpus of medical-training dataset includes the plurality of medical questions. In an embodiment of the present disclosure, the plurality of medical questions does not have answers for the plurality of medical questions. In another embodiment of the present disclosure, the plurality of medical questions does have answers associated with the plurality of medical questions. The plurality of medical questions is extracted from the one or more sources. In an example, the plurality of medical questions does not provide relevant answers for the plurality of medical questions. In an embodiment of the present disclosure, the plurality of medical questions provides data and information about questions that may be asked by the user 102 in future.

In an embodiment of the present disclosure, the corpus of medical-training dataset includes the plurality of medical articles. The plurality of medical articles is extracted from the one or more sources. The plurality of medical articles provides medical facts outside the context of question-answering. The plurality of medical facts is used to train the virtual medical assistant system 204 for continuation of the bi-directional conversation between the user 102 and the virtual medical assistant system 204. In another embodiment of the present disclosure, the corpus of medical-training dataset includes the plurality of medical conversations extracted from the one or more sources.

Further, the virtual medical assistant system 204 creates word embedding of words present in the corpus of medical-training dataset in a low dimensional vector space during training. In an embodiment of the present disclosure, the virtual medical assistant system 204 creates sentence embedding of sentence occurring in the plurality of medical questions during training of the virtual medical assistant system 204. The word-embedding of words is created using one or more methods. The one or more methods used to create the word embedding includes recurrent neural networks, convolutional neural networks, word embedding layer, word2vec algorithm, glove algorithm and the like. In an embodiment of the present disclosure, the virtual medical assistant system 204 uses recurrent neural networks to create the sentence embedding of sentences occurring in the corpus of medical-training dataset. In another embodiment of the present disclosure, the virtual medical assistant system 204 uses convolutional neural networks to create the sentence embedding of sentences occurring in the corpus of medical-training dataset. However, the virtual medical assistant system 204 is not limited to above mentioned networks and methods to create the sentence embedding of sentences occurring in the corpus of medical-training dataset.

In addition, the training of the virtual medical assistant system 204 facilitates learning of the virtual medical assistant system 204. The learning of the virtual medical assistant system 204 initially includes crawling the corpus of medical-training dataset to obtain the plurality of the dialogue conversations from the corpus of medical-training dataset. Further, the learning of the virtual medical assistant system 204 includes manual annotation of questions based on a plurality of criteria. In an embodiment of the present disclosure, the plurality of criteria includes user feedback, new content sources, popular questions and the like. Further, the manual annotation of questions is followed by binary annotation of the dialogue conversations. Further, the learning of the virtual medical assistant system 204 is continued by building automatic classifiers for prioritizing the plurality of dialogue conversations. The automatic classifiers are built using a plurality of hardware-run machine learning algorithms. The plurality of hardware-run machine learning algorithms includes Random Forest, Adaboost, Naive Bayes, Support Vector Machine algorithm and the like.

Furthermore, the training of the virtual medical assistant system 204 is continued by extracting a plurality of dialogue conversations from the corpus of the medical-training dataset based on the created word embedding. In an embodiment of the present disclosure, the training of the virtual medical assistant system 204 is continued by extracting the plurality of dialogue conversations from the corpus of the medical-training dataset based on the created sentence embedding. The plurality of dialogue conversations are conversations between a plurality of users and a plurality of professional medical practitioners. The plurality of dialogue conversations are extracted from the corpus of medical-training dataset using natural language processing algorithms and speech recognition algorithms.

In an embodiment of the present disclosure, the plurality of dialogue conversations are medical triage conversations performed between the plurality of users and the plurality of medical practitioners. In an embodiment of the present disclosure, the virtual medical assistant system 204 is trained with the plurality of dialogue conversations to assess level of severity of condition of the user 102. Further, the virtual medical assistant system 204 access the level of severity of condition of the user 102 to determine whether the user 102 requires emergency medical attention, primary care, home care and the like. In an embodiment of the present disclosure, the plurality of dialogue conversations is converted into machine-usable form using decision trees. In general, the decision tree is a decision support tool that uses a tree-like graph or model of decisions and their possible consequences, including chance event outcomes, resource costs, and utility. In another embodiment of the present disclosure, the plurality of dialogue conversations is converted into machine-usable form using hardware-run deep learning algorithms.

Further, the training of the virtual medical assistant system 204 is continued by prioritizing the plurality of extracted dialogue conversations based on the one or more medical protocols. In an embodiment of the present disclosure, the virtual medical assistant system 204 automatically prioritizes the plurality of extracted dialogue conversations using the hardware-run deep learning algorithms. In another embodiment of the present disclosure, the plurality of extracted dialogue conversations is prioritized manually in the virtual medical assistant system 204. The prioritization is done to train the virtual medical assistant system 204 to learn an appropriate utterance to respond to the user 102 from the corpus of medical-training dataset in future. The plurality of dialogue conversations extracted is prioritized based on a confidence score. The confidence score determines amount of confidence in the plurality of answers to reply as response to the plurality of questions.

In an embodiment of the present disclosure, the virtual medical assistant system 204 creates sentence embedding of entire sentences in the plurality of dialogue conversations. In an embodiment of the present disclosure, the plurality of dialogue conversations are represented as decision trees based on the one or more medical protocols. The sentence embedding of entire sentences is created by embedding entire sentences in the low-dimensional vector space. Further, the sentence embedding is used in sequence to sequence network (also termed as encoder decoder architecture) to produce end-to-end trainable neural translation models. In an embodiment of the present disclosure, the decoder uses global embedding to generate natural language from different language that was embedded by the decoder. In an embodiment of the present disclosure, the sentence embedding is generated using recurrent neural networks (hereinafter RNN), convolutional neural networks, and combinations thereof.

In an embodiment of the present disclosure, the RNN is trained in such a manner that similarity measure of two matching embedding is maximal. In addition, the RNN is trained in such a manner that similarity measure of two mismatched embedding is minimal. The RNN is trained using a ranking loss function to achieve above stated objectives during training of the RNN. In an embodiment of the present disclosure, the word embedding for the enquired question is considered to be as x_{Q}. In an embodiment of the present disclosure, the word embedding for true answer of the enquired question is considered to be as x_{QA}. In an embodiment of the present disclosure, the word embedding for false or incorrect answer of the enquired question is considered to be as x_{FA}. Thus, the ranking loss function is defined as:

L(x_{Q};x_{TA};x_{FA})=max(0,(M−(s(x_{Q};x_{tA})−s(x_{Q},x_{FA}))))

In addition, the cosine-similarity is used as measure s(⋅,⋅) and defined as s(x,y)=(x·y)/(∥x∥·∥y∥). In addition, M is margin parameter. The aim is to minimize the above stated loss to encourage margin between correct and incorrect pairings of the embedding. Further, the similarity for correct pairings is at least M larger than similarity of incorrect pairing. In addition, a single training input includes a question, its correct answer, and a randomly chosen incorrect answer.

Further, the virtual medical assistant system 204 initializes a bi-directional conversation between the virtual medical assistant system 204 and the user 102 through the computing device 104 in real-time. The bi-directional conversation is initialized on the computing device 104 associated with the user 102. In an embodiment of the present disclosure, the virtual medical assistant system 204 initially greets the user 102 with a greeting message on startup. In an example, the virtual medical assistant system 204 greets the user 102 with message such as “Hi! How are you?” and the like. In another embodiment of the present disclosure, the virtual medical assistant system 204 enquires a first question from the user 102. In an example, the virtual medical assistant system 204 enquires the user 102 with question such as “How are you feeling today?” In yet another embodiment of the present disclosure, the user 102 initially enquires a question from the virtual medical assistant system 204. The bi-directional conversation is initialized to facilitate the virtual medical assistant system 204 to provide medical assistance to the user 102.

The bi-directional conversation is initialized between the virtual medical assistant system 204 and the user 102 in the plurality of input forms. In an embodiment of the present disclosure, the bi-directional conversation is initialized between the virtual medical assistant system 204 and the user 102 in textual form. In another embodiment of the present disclosure, the bi-directional conversation is initialized between the virtual medical assistant system 204 and the user 102 in the form of images. In yet another embodiment of the present disclosure, the bi-directional conversation is initialized between the virtual medical assistant system 204 and the user 102 in the form of audio. In yet another embodiment of the present disclosure, the bi-directional conversation is initialized between the virtual medical assistant system 204 and the user 102 in the form of videos. In yet another embodiment of the present disclosure, the bi-directional conversation is initialized between the virtual medical assistant system 204 and the user 102 in the form of animation, gif, hand-written form and the like. Further, the virtual medical assistant system 204 retrieves specific concept from individual sentences of the bi-directional conversation using natural the language processing algorithms and the speech recognition algorithms.

The virtual medical assistant system 204 creates a health profile of the user 102. In an embodiment of the present disclosure, the virtual medical assistant system 204 creates the health profile of the user 102 before initialization of the bi-directional conversation. In another embodiment of the present disclosure, the virtual medical assistant system 204 creates the health profile of the user 102 after initialization of the bi-directional conversation based on context of the bi-directional conversation. In an embodiment of the present disclosure, the health profile of the user 102 is stored at the database 208. The health profile of the user 102 is created based on a plurality of factors. The plurality of factors include health related information associated with the user 102, disease prevalence of the user 102, lifestyle of the user 102, environmental conditions of the user 102, socioeconomic conditions affecting the user 102, medical reports associated with the user 102, previous interaction of the user 102 with the virtual medical assistant system 204 and the like. In an embodiment of the present disclosure, the health profile of the user 102 is created based on a set of data collected from one or more health related devices associated with the user 102. In an example, the health profile of the user 102 is created based on diseases the user 102 is currently suffering from. In another example, the health profile of the user 102 includes commonness of disease that re-occurs to the user 102 after an interval of time. In yet another example, the health profile of the user 102 includes health related information associated with the user 102 such as name, age, sex, blood group, hemoglobin level, number of platelets, and the like. In yet another embodiment of the present disclosure, the health profile of the user 102 includes previous medical reports associated with the user 102.

In an embodiment of the present disclosure, the virtual medical assistant system 204 collects data from the user 102 for creating the health profile of the user 102. The virtual medical assistant system 204 collects the data such as medical reports associated with the user 102, socioeconomic conditions affecting the user 102 and the like to create the health profile of the user 102. In addition, the virtual medical assistant system 204 is connected with the one or more health related devices associated with the user 102. In an example, the one or more health related devices include activity trackers, smart watches, smartphones, wearable and the like. The virtual medical assistant system 204 fetches the set of data associated with health status of the user 102 from the one or more connected health related devices. The virtual medical assistant system 204 fetches the set of data from the one or more connected health related devices to create the health profile of the user 102. In an embodiment of the present disclosure, the virtual medical assistant system 204 determines health status of the user 102 based on the set of data fetched from the one or more connected health related devices. The set of data fetched is stored in the health profile associated with the user 102. The virtual medical assistant system 204 initializes a concept identification module to parse text present in the bi-directional conversation. Further, the concept identification module retrieves specific concept from the bi-directional conversation. In an embodiment of the present disclosure, the concept identification module parses text to create the word embedding. In another embodiment of the present disclosure, the concept identification module parse text to create the sentence embedding. The concept identification module is initialized to identify context of the bi-directional conversation. The concept identification module is initialized to determine if the specific concept match with the one or more medical protocols. Further, the virtual medical assistant system 204 represents the retrieved specific concept as word embedding in the low dimensional vector space. In addition, the virtual medical assistant system 204 represents the retrieved specific concept as sentence embedding in the low dimensional vector space.

In an embodiment of the present disclosure, the virtual medical assistant system 204 creates word embedding of words present in the health profile of the user 102. In another embodiment of the present disclosure, the virtual medical assistant system 204 creates sentence embedding of sentences present in the health profile of the user 102. In an embodiment of the present disclosure, the word embedding of words present in the health profile of the user 102 is represented in the low dimensional vector space. In another embodiment of the present disclosure, the sentence embedding of sentences present in the health profile of the user 102 is represented in the low dimensional vector space. In an embodiment of the present disclosure, the concept identification module retrieves specific concept from the health profile of the user 102. In an embodiment of the present disclosure, the concept identification module parses text present in the health profile of the user 102 to create the word embedding. In another embodiment of the present disclosure, the concept identification module parses text present in the health profile of the user 102 to create the sentence embedding.

The virtual medical assistant system 204 maps the word embedding of the retrieved specific concept from the enquired question with the word embedding of words created from the corpus of medical-training dataset. The mapping is done to determine the appropriate utterance as response to the enquired question in context of the bi-directional conversation. The context is concatenation of the enquired question as well as past utterances by the user 102 and the virtual medical assistant system 204. The mapping is done to determine the appropriate utterance as response even when the word embedding of the retrieved specific concept from the enquired question is not present in the word embedding of words created from the corpus of medical-training dataset using deep learning. The appropriate utterance as response is determined with an associated confidence level. The mapping is done based on a plurality of deep learning algorithms and neural network models.

In an embodiment of the present disclosure, the virtual medical assistant system 204 interactively replies the user 102 with the appropriate utterance based on the health profile of the user 102. In an embodiment of the present disclosure, the virtual medical assistant system 204 interactively replies the user 102 with the appropriate utterance based on the health status of the user 102. In an example, the virtual medical assistant system 204 analyzes various medical records, the first set of data fetched from the one or more medical devices, and the like to create the health profile of the user 102. Further, the virtual medical assistant system 204 utilizes the training data as well as the analyzed data from the health profile of the user 102 to respond to the question enquired by the user 102. In an embodiment of the present disclosure, the virtual medical assistant system 204 analyzes the health profile of the user 102 to continue the bidirectional conversation between the virtual medical assistant system 204 and the user 102. The virtual medical assistant system 204 continues the bidirectional conversation with the user 102 based on the determined health status of the user 102. In addition, the virtual medical assistant system 204 responds to the enquired questions of the user 102 based on the data associated with the health profile of the user 102. In an example, the health profile of user X shows that the user X is suffering from diabetes. Further, the user X enquires questions related to diabetes from the virtual medical assistant system 204. Furthermore, the virtual medical assistant system 204 uses sources such as the data stored in the health profile of the user 102, previous interactions of the user 102 with the virtual medical assistant system 204, the training data and the like to interactively respond and continue the bi-directional conversation with the user 102.

Further, the mapping of the word embedding of the retrieved specific concept from the enquired question with the word embedding of words created from the corpus of medical-training dataset includes mapping the enquired question from the user 102 with the questions present in the plurality of dialogue conversations. The mapping is performed based on the context of the bi-directional conversation using unsupervised deep learning algorithms. In an embodiment of the present disclosure, the mapping is performed based on the context of the bi-directional conversation using word vector embedding. In an example, the virtual medical assistant system 204 scans through large streams of data present in the corpus of medical-training dataset. Further, the virtual medical assistant system 204 creates the low dimensional vector space where words that are same as well as have similar meaning are represented closer to each other. In addition, the low dimensional vector space includes the sentences that are same or have similar meaning to each other. In an example, the plurality of questions from the plurality of dialogue conversations is mapped to determine the most relevant utterance as response to the user 102 for the enquired question by the user 102.

Furthermore, the mapping of the word embedding of the retrieved specific concept from the enquired question with the word embedding of words created from the corpus of medical-training dataset includes mapping the enquired question from the user 102 with answers present in the plurality of dialogue conversations. The mapping is performed based on the context of the bi-directional conversation using supervised deep learning algorithms. In an example, the RNN (conversational network) is trained to predict the appropriate utterance as response to the enquired question by the user 102. The virtual medical assistant system 204 is trained to learn to interpret semantic information present in the enquired question to map with the appropriate utterance or relevant answer to the enquired question. The virtual medical assistant system 204 determines the appropriate utterance as response to the enquired question even if the enquired question is not present in the corpus of medical-training dataset based on the semantic information.

In an embodiment of the present disclosure, the virtual medical assistant system 204 uses algorithms based on artificial intelligence, deep learning and the like to interpret meaning of the question enquired by the user 102. The virtual medical assistant system 204 utilizes sequence to sequence learning to enable the bi-directional conversation between the user 102 and the virtual medical assistant system 204. In an embodiment of the present disclosure, the virtual medical assistant system 204 uses a second RNN to update the corpus of medical-training dataset with acquired information from the bi-directional conversation. In an embodiment of the present disclosure, the second RNN is a semantic RNN. Further, the semantic RNN takes the encoded semantic states from conversation network (first RNN network) as input. Furthermore, the semantic RNN uses the semantic states to inform next follow-up question to continue the bi-directional conversation. In addition, the semantic RNN uses the semantic states to inform useful medical facts for the user 102 based on the context of the conversation to continue the bi-directional conversation.

In an embodiment of the present disclosure, a probability distribution is maintained over the plurality of medical facts present in the database 208. Further, the probability distribution is maintained over the plurality of medical facts at each step of the bi-directional conversation. Furthermore, the virtual medical assistant system 204 replies to the user 102 with the plurality of medical facts when the virtual medical assistant system 204 is confident enough about what the user 102 is enquiring about based on the maintained probability distribution of the plurality of medical facts. In an embodiment of the present disclosure, the virtual medical assistant system 204 interactively replies to the enquired question along with the plurality of medical facts.

In an embodiment of the present disclosure, the word embedding of enquired question by the user 102 should converge respectively with the word embedding of appropriate utterance to be replied by the virtual medical assistant system 204. The word embedding should converge such that a similarity measure between the enquired question and the relevant response is highest when the answer matches with the enquired question. In an embodiment of the present disclosure, the virtual medical assistant system 204 tokenizes the context and utterances to insert special delineation tokens between the context and utterances. The virtual medical assistant system 204 inserts the special delineation tokens to distinguish between responses of the virtual medical assistant system 204 and the user 102.

In an embodiment of the present disclosure, the virtual medical assistant system 204 is trained using embedding functions. Further, the virtual medical assistant system 204 utilizes embedding functions for embedding context pairs using the ranking loss function. Furthermore, the virtual medical assistant system 204 utilizes embedding functions for embedding context and utterance pairs using the ranking loss function.

The virtual medical assistant system 204 interactively replies to the enquired question by the user 102 with the determined appropriate utterance as response with the associated confidence level. The virtual medical assistant system 204 interactively replies to the enquired question in a plurality of output forms. The plurality of output forms include at least one of text, image, audio, video, gif and animation.

In an embodiment of the present disclosure, the virtual medical assistant system 204 interactively replies with the appropriate utterance in the form of text. In another embodiment of the present disclosure, the virtual medical assistant system 204 interactively replies with images and videos related to the question enquired by the user 102. In yet another embodiment of the present disclosure, the virtual medical assistant system 204 interactively replies with audios related to the question enquired by the user 102. In yet another embodiment of the present disclosure, the virtual medical assistant system 204 interactively replies with gif, animations and the like related to the question enquired by the user 102.

The virtual medical assistant system 204 updates a health profile of the user 102 and the corpus of medical-training dataset in real-time using recurrent neural networks. The virtual medical assistant system 204 does updating based on the enquired questions from the user 102 that are not present in the word embedding of words created from the corpus of the medical-training dataset. Further, the virtual medical assistant system 204 determines health status of the user 102. The virtual medical assistant determines the health status of the user 102 based on one or more health related devices connected with the virtual medical assistant system 204. Also, the virtual medical assistant system 204 determines the health status of the user 102 based on the interaction history of the user 102 with the virtual medical assistant system 204. In an embodiment of the present disclosure, the virtual medical assistant system 204 is machine learning based medical assistant that enables the interactive dialogue session between the user 102 and the virtual medical assistant system 204. The virtual medical assistant system 204 interactively replies to the one or more questions enquired by the user 102 automatically. In addition, the virtual medical assistant system 204 initializes the bi-directional conversation between the user 102 and the virtual medical assistant system 204. Also, the virtual medical assistant system 204 enquires questions from the user 102 to get better idea about the health status of the user 102. In an embodiment of the present disclosure, the virtual medical assistant system 204 is based on natural language processing algorithms, information retrieval algorithms, knowledge representation algorithms, semantic web algorithms, medical informatics algorithm and the like. In general, the natural language processing is defined as automatic manipulation of natural language such as speech, text, and the like by computer system. In general, the information retrieval is the activity of obtaining information system resources relevant to an information need from a collection of information resources. In general, the knowledge representation is the field of artificial intelligence dedicated towards representing information about the world in a form that computer system can utilize to solve complex tasks. In an example, the complex tasks include tasks such as diagnosing a medical condition, having a dialog in a natural language and the like. In general, the semantic web is a proposed development of World Wide Web in which data in web pages is structured and tagged in such a way that it can be read directly by computers. In general, the medical informatics is the intersection of information science, computer science, and health care.

In an embodiment of the present disclosure, the virtual medical assistant system 204 enables the interactive dialogue session between the user 102 and the virtual medical assistant system 204 in one or more languages. The virtual medical assistant system 204 may be trained in any one of the one or more languages. Further, the virtual medical assistant system 204 may respond to the user 102 in specified language of the one or more languages. In an embodiment of the present disclosure, the interactive dialogue session between the user 102 and the virtual medical assistant system 204 is enabled in English language. In another embodiment of the present disclosure, the interactive dialogue session between the user 102 and the virtual medical assistant system 204 is enabled in Hindi language. In yet another embodiment of the present disclosure, the interactive dialogue session between the user 102 and the virtual medical assistant system 204 is enabled in any language of the one or more languages such as Spanish, Tamil, Marathi, Telugu, Chinese, Japanese and the like.

In an example, the virtual medical assistant system 204 learns and updates itself dynamically in real-time. The virtual medical assistant system 204 automatically learns to respond to the question enquired by the user 102 in real-time. The virtual medical assistant system 204 uses past interaction history of the user 102 as well as the corpus of medical-training dataset to interactively reply the user 102 with the appropriate responses. The virtual medical assistant system 204 responds to the questions enquired by the user 102 based on hardware-run machine learning algorithms.

In an embodiment of the present disclosure, the virtual medical assistant system 204 updates the health profile of the user 102 in real-time. The virtual medical assistant system 204 updates the health profile of the user 102 based on the bi-directional conversation between the virtual medical assistant system 204 and the user 102. In an embodiment of the present disclosure, the virtual medical assistant system 204 updates the health profile of the user 102 based on the context of the bidirectional conversation. In an embodiment of the present disclosure, the virtual medical assistant system 204 updates the health profile of the user 102 based on the training data collected in real-time.

In an embodiment of the present disclosure, the virtual medical assistant system 204 is intelligent enough to detect how to output the appropriate utterance as response in the plurality of output forms. In an example, the virtual medical assistant system 204 interactively replies to the user 102 in the form of audio or video when the virtual medical assistant system 204 feels requirement to do so.

In an example, the virtual medical assistant system 204 enables the interactive dialogue session between the user 102 and the virtual medical assistant system 204. The user 102 initializes the bi-directional conversation by enquiring the virtual medical assistant system 204 “Can I drink alcohol with my malaria pills?” The virtual medical assistant system 204 may enquire the user 102 back such as “What is the name of your malaria pills?” Further, the user 102 responds to the virtual medical assistant system 204 with name of the malaria pills. Furthermore, the virtual medical assistant system 204 may interactively reply back to the user 102 with appropriate utterances such as “I would not recommend drinking alcohol with Malarone pills. The pills may cause dizziness which can worsen with alcohol”.

In an embodiment of the present disclosure, the virtual medical assistant system 204 is designed based on a plurality of objectives. The first objective of the plurality of objectives of the virtual medical assistant system 204 is to converse fluently in natural language. In an example, suppose the user 102 enquires the virtual medical assistant system 204 “Should I go see the doctor?” The virtual medical assistant system 204 should interactively reply the user 102 with the appropriate utterance such as “Yes, you should go see the doctor”. The virtual medical assistant system 204 should not reply with something inappropriate such as “My name is Sam”. The second objective of the plurality of objectives of the virtual medical assistant system 204 is to produce accurate, reliable and appropriate utterances to the enquired question from medical point of view. The second objective of the plurality of objectives is achieved by associating each utterance as response to the user 102 with the confidence level. In addition, the second objective of the plurality of objectives is achieved by converting the utterances into fact-based utterances. In an example, the virtual medical assistant system 204 may respond something as “If you have taken Malarone and are experiencing severe dizziness, you should go see your doctor”.

In an embodiment of the present disclosure, the virtual medical assistant system 204 is based on RNN architecture. In general, the recurrent neural networks are neural network models that operate over sequential data and show strong ability for modeling natural language. The RNN-based sequence to sequence models obtain state-of-the-art performance in context of conversations and question-answering. The RNN is used to read an input sequence (the enquired question, for example) one word at a time. Further, the RNN encodes the input sequence into a state vector that compresses semantic information. Further, the semantic information is used to initialize the second RNN that decodes the semantic information to produce the appropriate response, output one word at a time. The virtual medical assistant system 204 is trained through reading a plurality of examples of question-answer or statement-response pairs. Further, the virtual medical assistant system 204 determines most similar medical question whose answer has already been trained to the virtual medical assistant system 204. Furthermore, the virtual medical assistant system 204 returns the most appropriate utterance as response corresponding to context of the enquired question by the user 102. Also, the virtual medical assistant system 204 determines most similar medical answer even when the question has not already been trained to the virtual medical assistant system 204 based on deep learning algorithms.

In an embodiment of the present disclosure, the virtual medical assistant system 204 achieves performance in Top-1 accuracy and mean reciprocal rank metrics. In general, the Top-1 accuracy is how many times correct label has highest probability predicted by network. In general, the mean reciprocal rank is a statistic measure for evaluating any process that produces a list of possible responses to a sample of queries, ordered by probability of correctness.

In an embodiment of the present disclosure, the virtual medical assistant system 204 tokenizes the context and utterances present in the word embedding of words created from the corpus of medical-training dataset. In addition, the virtual medical assistant system 204 tokenizes the word embedding of the retrieved specific concept from the enquired question. The virtual medical assistant system 204 tokenizes the contexts and utterances based on length of the contexts and utterances. In an embodiment of the present disclosure, the length of token for question or context is specified to be of 30 tokens. However the length of token for contexts may be changed accordingly. In an embodiment of the present disclosure, the length of token for utterances is specified to be of 70 tokens. However the length of token for utterances may be changed accordingly. In an embodiment of the present disclosure, the loss percentage is kept at less than 2%. However, the loss percentage is not fixed at 2%. In an embodiment of the present disclosure, the virtual medical assistant system 204 discards the tokenized contexts having length greater than 30 tokens. In an embodiment of the present disclosure, the virtual medical assistant system 204 discards the tokenized utterances having length greater than 70 tokens. In addition, the virtual medical assistant system 204 adds zero-padding to the pairs of contexts and utterances that are less than 30 tokens and 70 tokens respectively.

Further, the virtual medical assistant system 204 replaces words that are out of vocabulary with special tokens. Further, the tokens are converted to one-hot vector representation. In general, the one-hot vector representation is a way of vector representation in which all elements of the vector are zero except one, which has one as its value. Further, the list of one-hot vectors representation is fed to the RNN. In an embodiment of the present disclosure, the virtual medical assistant system 204 uses long short term memory (hereinafter, LSTM) as RNN. In general, the LSTM units are units of the RNN. In general, the LSTM unit is composed of a cell, an input gate, an output gate and a forget gate. Further, the cell remembers values over arbitrary time intervals and the three gates regulate the flow of information into and out of the cell. However, the virtual medical assistant system 204 is not limited to using LSTM as RNN.

Further, the recurrent layer of the RNN is applied with dropout to prevent overfitting. In general, the dropout is a regularization technique for neural networks where randomly selected neurons are ignored during training. In general, the overfitting is a modeling error which occurs when a function is too closely fit to a limited set of data points. In an embodiment of the present disclosure, the output of the RNN at last timestamp is fed to a fully connected layer with tanh nonlinearity. In general, the fully connected layers connect every neuron in one layer to every neuron in another layer. The output represents final embedding of the sentence.

In an embodiment of the present disclosure, the data processing, training and testing of the virtual medical assistant system 204 is done in Python. In an embodiment of the present disclosure, the GPU-compatible model of the virtual medical assistant system 204 is implemented using Keras library. In an embodiment of the present disclosure, the single-GPU compatible model takes a time period of about 40 minutes to iterate one epoch of about millions of question-answer pairs. In an embodiment of the present disclosure, the virtual medical assistant system 204 computes the word embedding of single question and the plurality of answers present in the plurality of dialogue conversations. The virtual medical assistant system 204 ranks answers by associating the confidence level with the answers. Further, the virtual medical assistant system 204 performs with the top-1 accuracy and mean reciprocal rank metrics. The top-1 accuracy measures fraction of instances where algorithm returns the true answer as its top choice in the ranking. In an example, the virtual medical assistant system 204 is trained to perform 2000 rankings. The virtual medical assistant system 204 is asked to rank 200 answers to a given question during each instance. Further, the questions and answers used for this evaluation are held out from training set as validation set. Further, the virtual medical assistant system 204 achieves performance of ˜0.41 mean reciprocal rank and ˜0.25 top-1 accuracy on this validation set.

In an example, the virtual medical assistant system 204 enables the bi-directional conversation by prompting the user 102 for enquiring a question. Further, the user 102 enquires the question from the virtual medical assistant system 204. The virtual medical assistant system 204 tokenizes the enquired question. Further, the virtual medical assistant system 204 performs sentence embedding of the enquired question using the trained RNN. The sentence embedding is compared with the embedding of all answers present in the training set using similarity measure. Further, the virtual medical assistant system 204 interactively replies to the user 102 with ten highest ranking answers.

In an example, the user 102 enquires the virtual medical assistant system 204 with “Do you think I am fat?” The virtual medical assistant system 204 replies interactively to the user 102 with appropriate utterances and their associated confidence level. The utterance having the most confidence level is denoted as rank 1 and utterance having the least confidence level is denoted as rank 10. In an example, the virtual medical assistant interactively replies as:

“Rank 1.0: “the body uses fat stores when it needs more calories than are taken in this can occur at any age”
Rank 2.0: “and what are you going to do about it I am sure that it can be calculated but the info is completely useless and devoid of any clinical implication you want to burn calories do it the only available way exercise.”
Rank 3.0: “by simply losing 5 to 10 pounds you will reduce the fat.”
Rank 4.0: “watch your calories and avoid hi cholesterol items.”
Rank 5.0: “always non-surgical such as a strict regimen of diet and exercise with a nutritionist on board that way you can keep the weight you lose with the lifestyle modification save abdominoplasty as a last resort best of luck.”
Rank 6.0: “nope you've got it 100 of calories come from either protein fat or carbohydrates the only caloric foods on planet earth.”
Rank 7.0: “you may participate in any con contact sports though low impact exercise like walking swimming will be better have a diet rich in fresh vegetables fruits whole grains nut slow fat milk products beans legumes lentils limit intake of saturated fats no tobacco nor alcohol.”
Rank 8.0: “if u maintain control over your caloric intake.”
Rank 9.0: “you do not qualify for such surgery and risks are real and significant a bariatric program can counsel you regarding diet exercise and eating behaviors.”
Rank 10.0: “a person need not take more than 30 of the calories in the form of fat.”

The answers provided by the virtual medical assistant system 204 become more accurate and precise as the training of the virtual medical assistant system 204 is continued.

In another example, the user 102 enquires the virtual medical assistant system 204 with “What are the symptoms of the flu?” The virtual medical assistant system 204 replies interactively to the user 102 with appropriate utterances and their associated confidence level. The utterance having the most confidence level is denoted as rank 1 and utterance having the least confidence level is denoted as rank 10. In an example, the virtual medical assistant interactively replies as:

Rank 1.0: “the symptoms you describe could be side effects of the amoxicillin she should contact the doctor who prescribed the amoxicillin to determine if a medication change is needed”.
Rank 2.0: “you don't have high fever typical in influenza.”
Rank 3.0: “sometimes amoxicillin can upset your stomach try another antibiotic discuss with your doctor.”
Rank 4.0: “stay as active as you can but at the end of the day get plenty of rest make sure to eat well and stay hydrated take meds to relieve symptoms and wash your hands frequently to prevent spreading this to others report to your doc if you take a sudden turn for the worse or symptoms become severe remember to get flu vaccine every year.”
ask your pcp what is he testing you for the eosinophils are increased in allergic conditions mostly seeing an allergist might be useful.”
Rank 6.0: “there can be more than one flu virus that you want to fend off.”
Rank 7.0: “hopefully you got a flu shot to prevent this kind of infection if not then go get tested for flu and start the appropriate medication.”
Rank 8.0: “no fever would not necessarily be present with the onset of the flu.”
Rank 9.0: “a flu shot should not cause arash.”
Rank 10.0: “some patients with flu have mild illness without fever.”

The answers provided by the virtual medical assistant system 204 become more accurate and precise as the training of the virtual medical assistant system 204 is continued.

In an embodiment of the present disclosure, the virtual medical assistant system 204 is improved in performance and quality based on tuning of one or more hyperparameters. The one or more hyperparameters include but may not be limited to learning rate and associated learning schedule, size and number of recurrent layers, dimensionality of the word embedding, and unsupervised pre-trained weights for the word embedding layer. Further, the one or more hyperparmeters include dimensionality of the sentence embedding layer, dropout and other regularization parameters, type of loss function or margin parameter, the similarity measure and the like. In addition, the virtual medical assistant system 204 is improved in quality by enabling weight-sharing between recurrent networks for questions as well as answers. Also, the virtual medical assistant system 204 is improved in quality by enabling weight-sharing in the word embedding layer as well. Further, the virtual medical assistant system 204 is improved in quality by training the virtual medical assistant system 204 with larger corpus of medical-training dataset.

In an embodiment of the present disclosure, the virtual medical assistant system 204 determines medical issue faced by the user 102. The virtual medical assistant system 204 determines the medical issue by checking for symptoms of diseases by retrieval of specific concepts from the bi-directional conversation initialized between the user 102 and the virtual medical assistant system 204. In an embodiment of the present disclosure, the virtual medical assistant system 204 checks for symptoms of the user 102 based on the health profile of the user 102. In an embodiment of the present disclosure, the virtual medical assistant system 204 checks for symptoms of the user 102 based on one or more hardware-run algorithms.

Further, the virtual medical assistant system 204 is connected with the server 206. In general, the server 206 is a computer program that provides service to another computer programs. In general, the server 206 may provide various functionalities or services, such as sharing data or resources among multiple clients, performing computation for a client and the like. In an example, the server 206 may be at least one of dedicated server 206, cloud server 206, virtual private server 206 and the like. However, the server 206 is not limited to above mentioned server 206s.

Further, the server 206 is connected with the database 208. In general, the database 208 is a collection of information that is organized so that it can be easily accessed, managed and updated. In an example, the database 208 may be one of at least hierarchical database 208, network database 208, relational database 208, object-oriented database 208 and the like. The database 208 provides storage location to the set of data, the health profile of data, the corpus of medical-training dataset, and the like. In an embodiment of the present disclosure, the database 208 provides storage location to all the data and information required by the virtual medical assistant system 204. In an example, the database 208 is connected to the server 206. The server 206 stores data in the database 208. The server 206 interacts with the database 208 to retrieve the stored data.

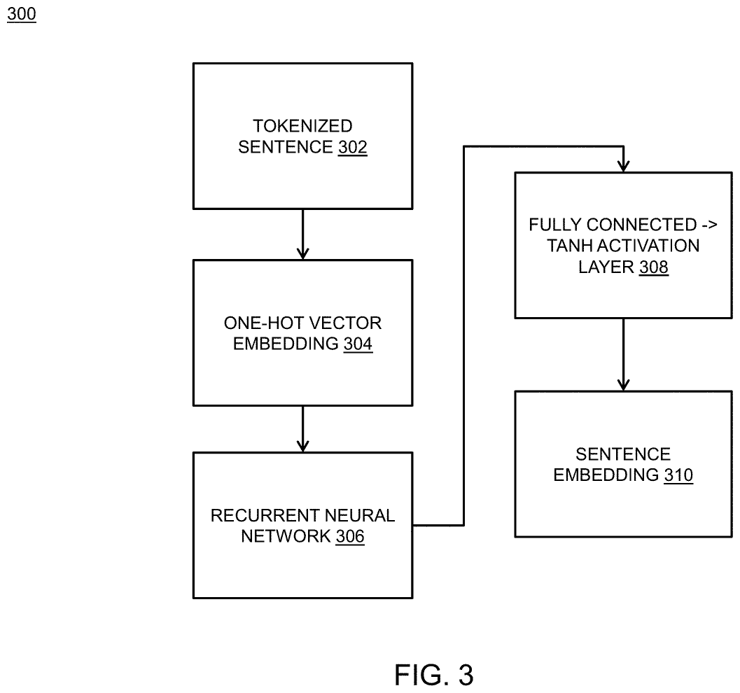

FIG. 3 illustrates a block diagram 300 of an example of RNN embedding model, in accordance with various embodiments of the present disclosure. It may be noted that to explain the process steps of block diagram 300, references will be made to the system elements of FIG. 1 and FIG. 2.

It is shown in FIG. 1 that the user 102 utilizes the computing device 104 to enable the bi-directional conversation between the virtual medical assistant system 204 and the user 102; however, those skilled in the art would appreciate that there may be more number of users connecting to the more number of computing devices.

The virtual medical assistant system 204 may be implemented using the single computing device 104, or a network of computing devices, including cloud-based computer implementations. The computing device 104 is preferably server class computers including one or more high-performance computer processors and random access memory, and running an operating system such as LINUX or variants thereof. The operations of the virtual medical assistant system 204 as described herein can be controlled through either hardware or through computer programs installed in non-transitory computer readable storage devices such as solid state drives or magnetic storage devices and executed by the processors to perform the functions described herein. The database 208 is implemented using non-transitory computer readable storage devices, and suitable database management systems for data access and retrieval. The virtual medical assistant system 204 includes other hardware elements necessary for the operations described herein, including network interfaces and protocols, input devices for data entry, and output devices for display, printing, or other presentations of data. Additionally, the operations listed here are necessarily performed at such a frequency and over such a large set of data that they must be performed by a computer in order to be performed in a commercially useful amount of time, and thus cannot be performed in any useful embodiment by mental steps in the human mind.

The block diagram 300 includes a tokenized sentence 302, one-hot vector embedding 304, a recurrent neural network 306, a fully connected->tan h activation layer 308, and a sentence embedding 310. The virtual medical assistant system 204 strips and tokenizes the enquired question. The tokenized sentence 302 is represented in the form of one-hot vector embedding 304. The one-hot vector embedding 304 representation of each word is fed through an embedding layer. Further, the embedded word representations are fed to the recurrent neural network 306. The output of the recurrent neural network 306 goes through the fully connected->tan h activation layer 308. Furthermore, the output of the fully connected->tan h activation layer 308 is fed to the sentence embedding 310 (as mentioned above).

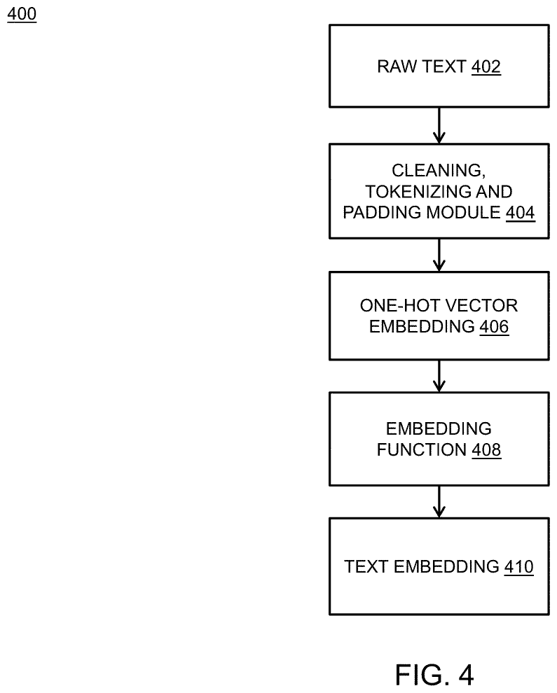

FIG. 4 illustrates a block diagram 400 of an example for implementation of word embedding by the virtual medical assistant system, in accordance with various embodiments of the present disclosure. It may be noted that to explain the process steps of block diagram 400, references will be made to the system elements of FIG. 1 and FIG. 2.

The block diagram 400 includes a raw text 402, a cleaning, tokenizing and padding module 404, one-hot vector embedding 406, an embedding function 408, and a text embedding 410. The raw text 402 is provided to the cleaning, tokenizing and padding module 404. The cleaning, tokenizing and padding module 404 strips and tokenizes the raw text 402. In addition, the cleaning, tokenizing and padding module 404 performs zero-padding to shorter text pieces from the raw text 402. Further, the cleaned, tokenized and padded text is represented in the form of the one-hot vector embedding 406. The one-hot vector embedding 406 representation of each word is passed through the embedding function 408. Further, the embedded word representations are fed to a recurrent neural network. The output of the recurrent neural network goes through a fully connected->tan h activation layer. Furthermore, the output of the fully connected->tan h activation layer represents the text embedding 410 (as mentioned above).

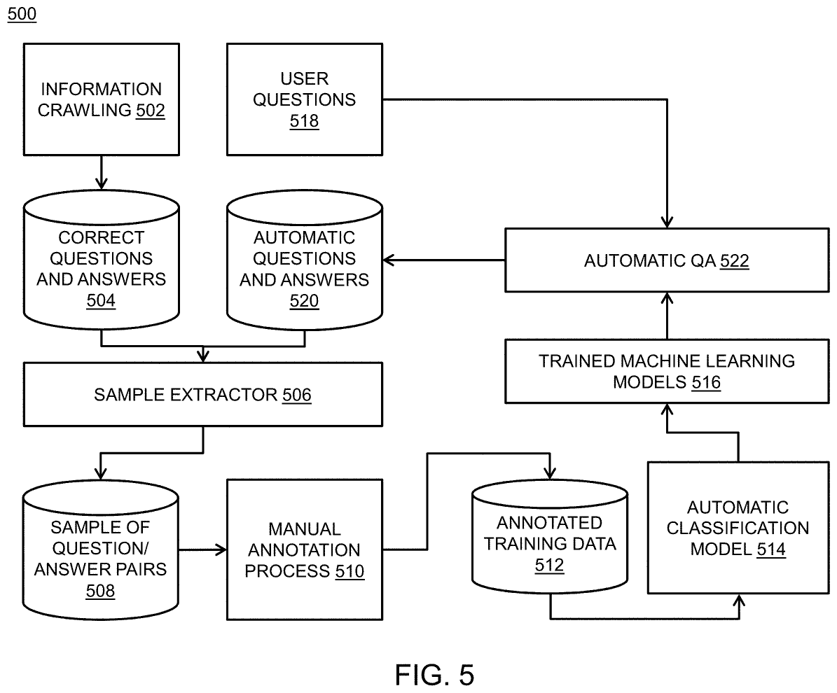

FIG. 5 illustrates a block diagram 500 for execution of learning of the virtual medical assistant system during training, in accordance with various embodiments of the present disclosure. It may be noted that to explain the process steps of block diagram 500, references will be made to the system elements of FIG. 1 and FIG. 2.

The block diagram 500 includes information crawling 502, correct questions and answers 504, a sample extractor 506, a sample of question answer pairs 508, a manual annotation process 510, an annotated training data 512, an automatic classification model 514, a trained machine learning model 516, user questions 518, automatic questions and answers 520, and automatic QA 522. The information crawling 502 refers to crawling of information from the corpus of medical-training dataset. The information crawling 502 is performed to find the correct questions and answers 504 from the corpus of medical-training dataset. Further, the correct questions and answers 504 are indexed by conceptual representation of their titles. In an embodiment of the present disclosure, the concepts are extracted by a hardware-run concept identification algorithm. The correct questions and answers 504 are fed to the sample extractor 506. Further, the sample extractor 506 extracts the sample of question answer pairs 508. The sample of question answer pairs 508 are fed to the manual annotation process 510. The manual annotation process 510 outputs the annotated training data 512. The annotated training data 512 is fed to the automatic classification model 514. In an embodiment of the present disclosure, the automatic classification model 514 trains one or more classifiers that assign the confidence level to the sample of question answer pairs 508. Further, the automatic classification model 514 is connected to the trained machine learning model 516. The trained machine learning model 516 is connected to the automatic QA 522. In addition, the user questions 518 represent questions enquired by the user 102. The user questions 518 are converted to the automatic questions and answers 520. Further, the automatic questions and answers 520 are fed to the automatic QA 522 (as mentioned above).

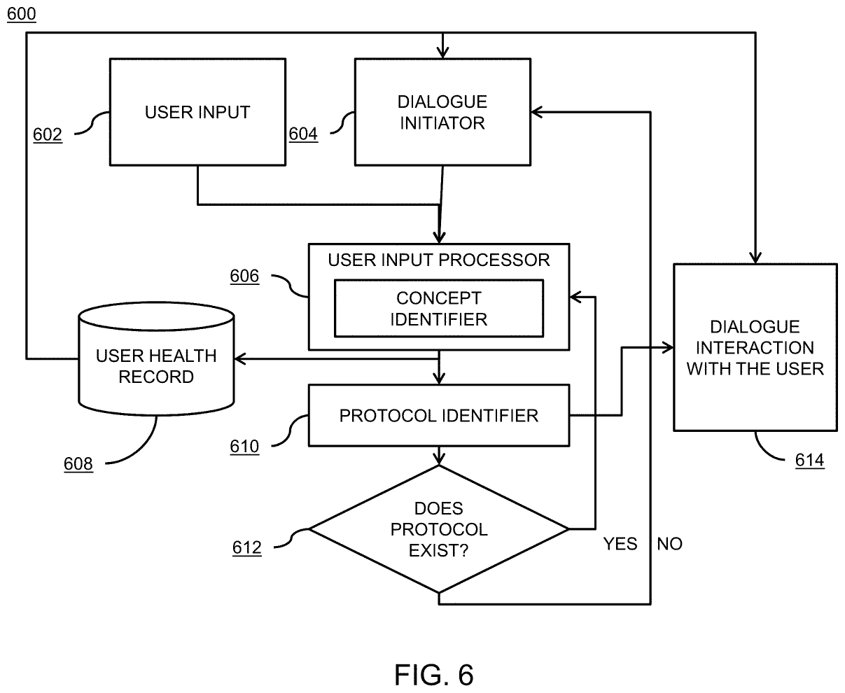

FIG. 6 illustrates a flow chart 600 for depicting internal representation of the interactive dialogue session conducted between the virtual medical assistant system 204 and the user 102, in accordance with various embodiments of the present disclosure. It may be noted that to explain the process steps of flowchart 600, references will be made to the system elements of FIG. 1 and FIG. 2.

The flowchart 600 includes a user input 602. The user input 602 is used to take input from the user. In an embodiment of the present disclosure, the user input 602 is used to take the enquired question from the user 102. The user input 602 is fed to a user input processor 606. In addition, the user input processor 606 includes a concept identifier. In addition, the flow chart 600 includes a dialogue initiator 604. The dialogue initiator 604 initiates the bi-directional conversation with the user 102. The dialogue initiator is converted to a user health record 608. The user health record 608 includes the health profile of the user 102. Further, the user input processor 606 processes input from the user 102. The input from the user 102 may include asking questions from the virtual medical assistant system 204, answering question asked by the virtual medical assistant system 204 and the like. In an embodiment of the present disclosure, the user health record 608 of the user 102 is updated when the user 102 answers question asked by the virtual medical assistant system 204. In another embodiment of the present disclosure, the concept identification module is applied when the user 102 enquires for new question. Further, the protocol identifier 610 searches for the one or more medical protocols to determine whether one or more concepts in the enquired question match with the one or more protocols. Further, the virtual medical assistant system 204 checks whether protocol exists or not at a step 612. If the protocol does not exist, the command goes back to the dialogue initiator 604. If the protocol exists, the dialogue interaction with the user 102 is continued until the virtual medical assistant system 204 provides medical assistance to the user 102 at step 614 (as mentioned above).

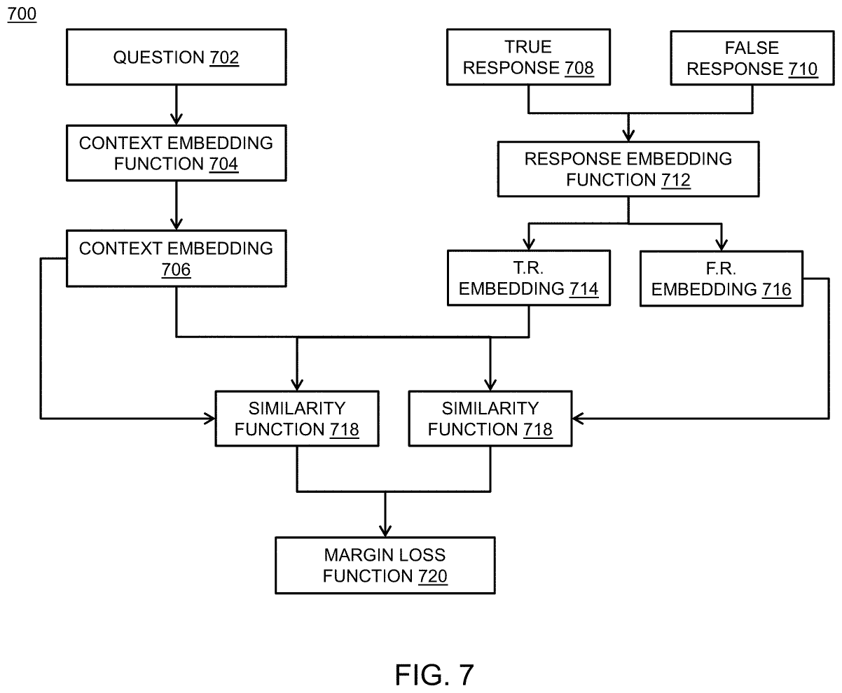

FIG. 7 illustrates a block diagram 700 of separate RNN's used for computation of the margin loss to be minimized during training of the virtual medical assistant system 204, in accordance with various embodiments of the present disclosure. It may be noted that to explain the process steps of block diagram 700, references will be made to the system elements of FIG. 1, and FIG. 2.

The block diagram 700 includes a question 702 that is enquired by the user 102 from the virtual medical assistant system 204. The question passes through a separate RNN for questions. The separate RNN for question is a context embedding function 704. In addition, a response embedding function 712 is a separate RNN for answers. Further, a true response 708 denotes correct answer for the question 702. Furthermore, a false response 710 denotes incorrect answer for the question 702. The word embedding of question is denoted as a context embedding 706. The word embedding for correct answer is denoted as a true response embedding 714. The word embedding for incorrect answer is denoted as a false response embedding 716. Further, the block diagram 700 includes a similarity function 718. In an embodiment of the present disclosure, the similarity function 718 is the ranking loss function. The similarity function 718 maps the embedding of the question 702 with embedding of correct answer. Further, the similarity function 718 gives the confidence score for correct question-answer pair. In addition, the similarity function 718 gives the confidence score for incorrect question-answer pair in a similar manner (as mentioned above). Furthermore, a margin loss 720 is applied to compute the margin loss. The margin loss 720 appears to be severe when the confidence score of incorrect pairing is not sufficiently much lower than the confidence score of correct pairing. The margin loss function 720 separates the incorrect pairing from the correct pairing. (as mentioned above)

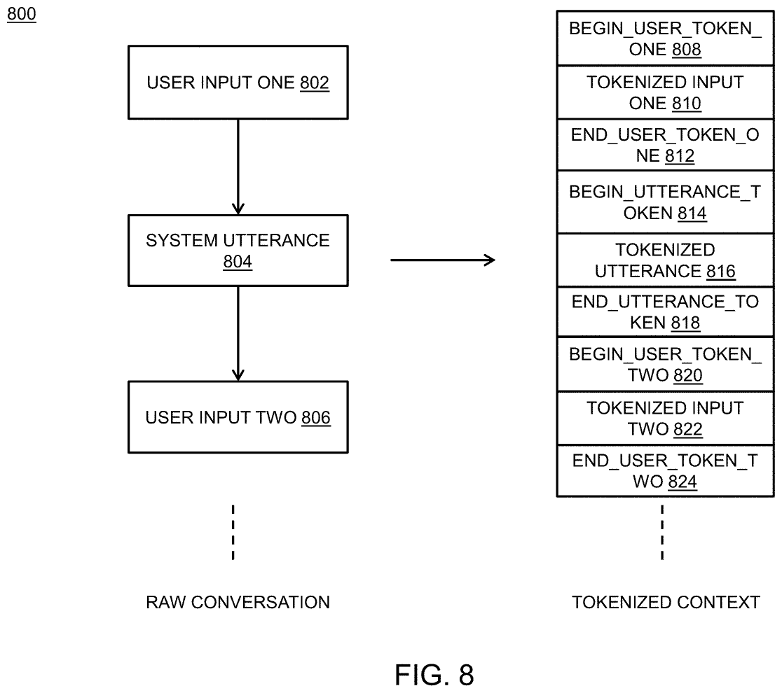

FIG. 8 illustrates an internal representation 800 of tokens and utterances during training of the virtual medical assistant system 204, in accordance with various embodiments of the present disclosure. It may be noted that to explain the internal representation 800, references will be made to the system elements of FIG. 1, and FIG. 2.

The internal representation 800 includes a user input 802. Further, the internal representation 800 includes a system utterance 804. Furthermore, the internal representation 800 includes a user input two 806. In addition, the internal representation 800 includes a begin_user_token_one 808. Moreover, the internal representation 800 includes a tokenized input 810. Further, the internal representation 800 includes an end_user_token_one 812. Furthermore, the internal representation 800 includes a begin_utterance_token 814. Also, the internal representation 800 includes a tokenized utterance 816. Moreover, the internal representation 800 includes an end_utterance_token 818. Further, the internal representation 800 includes a begin_user_token_two 820. Furthermore, the internal representation 800 includes a tokenized input two 822. In addition, the internal representation 800 includes an end_user_token_two 824. In an embodiment of the present disclosure, the user input one 802, the system utterance 804, the user input two 806, and the like represents raw conversation. In an embodiment of the present disclosure, the begin_user_token_one 808, the tokenized input 810, the end_user_token_one 812, the begin_utterance_token 814, the tokenized utterance 816, the end_utterance_token 818, the begin_user_token_two 820, the tokenized input two 822, the end_user_token_two 824, and the like represents tokenized context. The virtual medical assistant system inserts the tokens between utterances to differentiate between different utterances between the user and the virtual medical assistant system (as mentioned above).

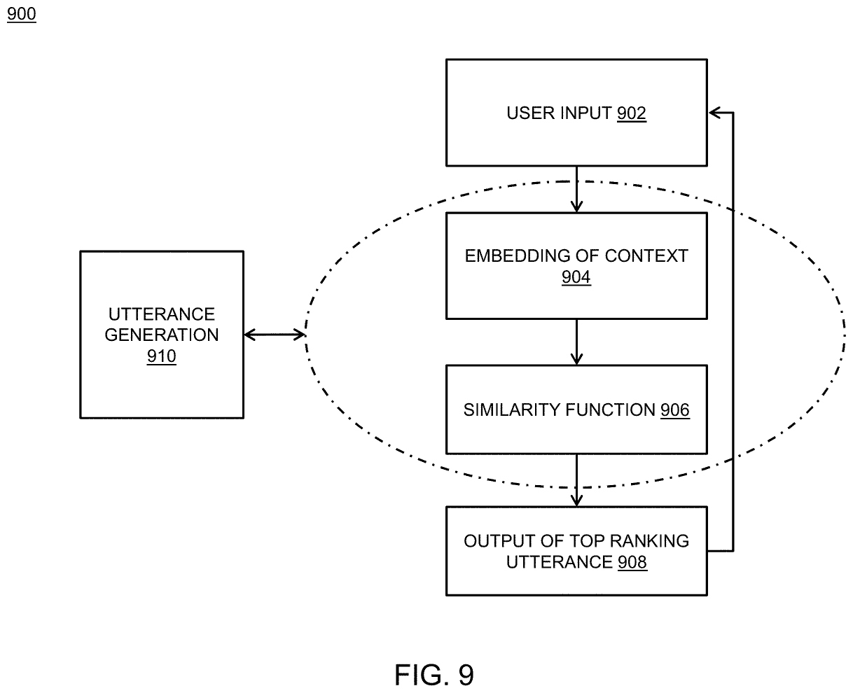

FIG. 9 illustrates a flow chart 900 for depicting a method to provide appropriate utterance as response by the virtual medical assistant system 204 to an enquired question from the user 102, in accordance with various embodiments of the present disclosure. It may be noted that to explain the flow chart 900, references will be made to the system elements of FIG. 1, and FIG. 2.

FIG. 9 includes a user input 902, an embedding of context 904, a similarity function 906, an output of top ranking utterance 908, and an utterance generation 910. The user input 902 refers to the enquired question by the user 102. In an example, the user 102 enquires the virtual medical assistant system 204 “What should I eat while suffering from fever?” The virtual medical assistant system 204 generates the embedding of context 904. The virtual medical assistant system 204 performs operations such as cleaning of the user input 902, tokenizing of the user input 902 and the like. Further, the virtual medical assistant system 204 generates the embedding of context 904. The utterance generation 910 is utilized to generate the embedding of context 904. In an embodiment of the present disclosure, the embedding of context 904 includes word embedding, sentence embedding and the like. In an embodiment of the present disclosure, the embedding of context 904 generates separate embedding of the context and separate embedding of the utterance. Furthermore, the virtual medical assistant system 204 applies the similarity function 906 to every pairing of embedding of the context and embedding of the utterance. The output of top ranking utterance 908 is presented to the user 102 (as mentioned above).

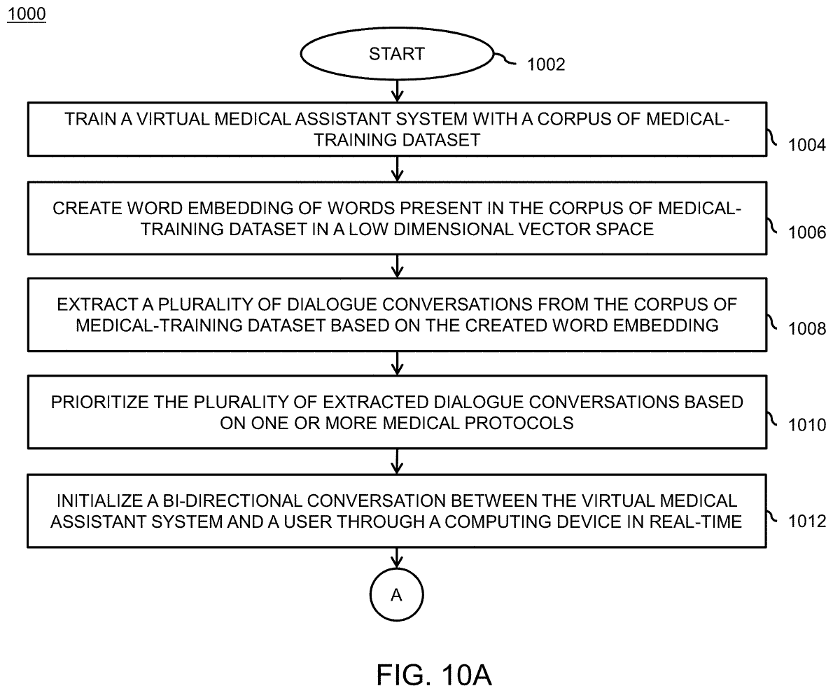

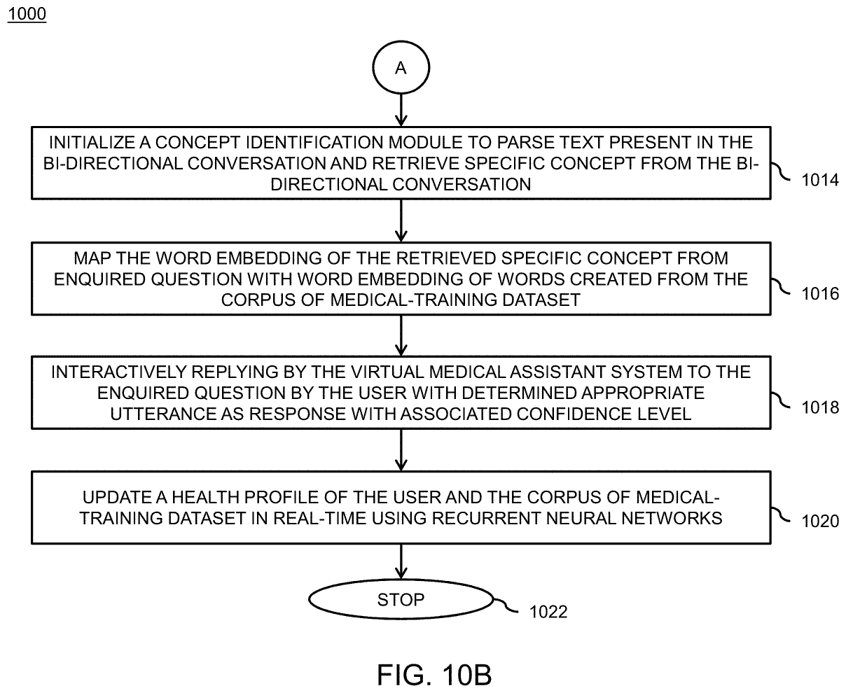

FIGS. 10A and 10B illustrate a flow chart 1000 for enabling the interactive dialogue session between the user and the virtual medical assistant system, in accordance with various embodiments of the present disclosure. It may be noted that to explain the process steps of flowchart 1000, references will be made to the system elements of FIG. 1 and FIG. 2. It may also be noted that the flowchart 1000 may have lesser or more number of steps.

The flowchart 1000 initiates at step 1002. Following step 1002, at step 1004, the virtual medical assistant system 1004 is trained with the corpus of medical-training dataset. At step 1006, the word embedding of words present in the corpus of medical-training dataset is created in the low dimensional vector space. At step 1008, the plurality of dialogue conversations are extracted from the corpus of medical-training dataset based on the created word embedding. At step 1010, the plurality of extracted dialogue conversations are prioritized based on one or more medical protocols. At step 1012, the bi-directional conversation is initialized between the virtual medical assistant system 204 and the user 102 through the computing device 104 in real-time. At step 1016, a concept identification module is initialized to parse text present in the bi-directional conversation and retrieve specific concept from the bi-directional conversation. At step 1018, the virtual medical assistant system 204 interactively replies to the virtual medical assistant system 204 to the enquired question by the user 102 with determined appropriate utterance as response with associated confidence level. At step 1020, a health profile of the user 102 and the corpus of medical-training dataset are updated in real-time using recurrent neural networks. The flow chart 1000 terminates at step 1022.

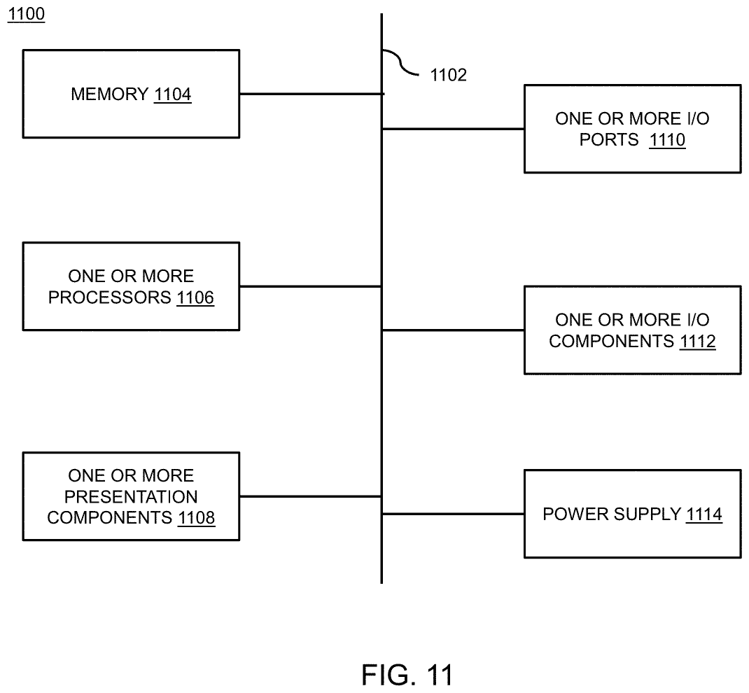

FIG. 11 illustrates a block diagram of a device 1100, in accordance with various embodiments of the present disclosure. In FIG. 11, the device 1100 illustrates internal structural overview of the computing device 104. The device 1100 is a non-transitory computer readable storage medium. The device 1100 includes a bus 1102 that directly or indirectly couples the following devices: memory 1104, one or more processors 1106, one or more presentation components 1108, one or more input/output (I/O) ports 1110, one or more input/output components 1112, and an illustrative power supply 1114. The bus 1102 represents what may be one or more busses (such as an address bus, data bus, or combination thereof). Although the various blocks of FIG. 11 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 11 is merely illustrative of an exemplary device 1100 that can be used in connection with one or more embodiments of the present invention. Distinction is not made between such categories as “workstation,” “server,” “laptop,” “hand-held device,” etc., as all are contemplated within the scope of FIG. 11 and reference to “computing device.”

The device 1100 typically includes a variety of computer-readable media. The computer-readable media can be any available media that can be accessed by the device 1100 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 1100. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1104 includes computer-storage media in the form of volatile and/or nonvolatile memory. The memory 1104 may be removable, non-removable, or a combination thereof. Exemplary hardware devices include solid-state memory, hard drives, optical-disc drives, etc. The device 1100 includes the one or more processors 1106 that read data from various entities such as memory 1104 or I/O components 1112. The one or more presentation components 1108 present data indications to a user or other device. Exemplary presentation components include a display device, speaker, printing component, vibrating component, etc. The one or more I/O ports 1110 allow the device 1100 to be logically coupled to other devices including the one or more I/O components 1112, some of which may be built in. Illustrative components include a microphone, joystick, game pad, satellite dish, scanner, printer, wireless device, etc.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and sub-combinations of the various elements, features, functions, and/or properties disclosed herein. The following claims particularly point out certain combinations and sub-combinations regarded as novel and nonobvious. Inventions embodied in other combinations and sub-combinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

We claim:

1. A computer-implemented method for enabling an interactive dialogue session between a user and a virtual medical assistant system, wherein the interactive dialogue session is enabled for providing medical assistance to the user, the computer-implemented method comprising:
training the virtual medical assistant system with a corpus of medical-training dataset, wherein the virtual medical assistant system is trained based on one or more medical protocols, wherein the virtual medical assistant system is trained with the corpus of the medical-training dataset in a plurality of input forms, wherein the training of the virtual medical assistant system comprises:
creating word embedding of words present in the corpus of the medical-training dataset in a low dimensional vector space, wherein the word embedding of words is created using one or more methods;
extracting a plurality of dialogue conversations from the corpus of the medical-training dataset based on the created word embedding, wherein the plurality of dialogue conversations are conversations between a plurality of users and a plurality of professional medical practitioners;
prioritizing the plurality of extracted dialogue conversations based on the one or more medical protocols, wherein the prioritization is done to train the virtual medical assistant system to learn an appropriate utterance to respond to the user from the corpus of the medical-training dataset;
initializing a bi-directional conversation between the virtual medical assistant system and the user through a computing device in real-time, wherein the bi-directional conversation is initialized by enquiring a question by the user or the virtual medical assistant system, wherein the bi-directional conversation is initialized to facilitate the virtual medical assistant system to provide the medical assistance to the user;
initializing a concept identification module to parse text present in the bi-directional conversation and retrieve specific concept from the bi-directional conversation, wherein the concept identification module is initialized to identify context of the bi-directional conversation, wherein the concept identification module is initialized to determine if the specific concept match with the one or more medical protocols, wherein the retrieved specific concept is represented as word embedding in the low dimensional vector space representation by the virtual medical assistant system;
mapping the word embedding of the retrieved specific concept from the enquired question with the word embedding of words created from the corpus of the medical-training dataset, wherein the mapping is done to determine the appropriate utterance as response to the enquired question in the context of the bi-directional conversation, wherein the context is concatenation of the enquired question as well as past utterances by the user and the virtual medical assistant system, wherein the mapping is done to determine the appropriate utterance as response even when the word embedding of the retrieved specific concept from the enquired question is not present in the word embedding of words created from the corpus of the medical-training dataset using deep learning, wherein the appropriate utterance as response is determined with an associated confidence level, wherein the mapping is done based on a plurality of deep learning algorithms and neural network models;
interactively replying by the virtual medical assistant system to the enquired question by the user with the determined appropriate utterance as response with the associated confidence level, wherein the virtual medical assistant system interactively replies to the enquired question in a plurality of output forms; and
updating a health profile of the user and the corpus of the medical-training dataset in real-time using recurrent neural networks, wherein the updating is done based on the enquired question from the user that are not present in the word embedding of words created from the corpus of the medical-training dataset,
wherein the bi-directional conversation is continued until the user is provided the complete medical assistance by the virtual medical assistant system.

2. The computer-implemented method as recited in claim 1, wherein the corpus of the medical-training dataset comprises of a plurality of question-answer pairs, a plurality of medical questions, a plurality of medical articles and a plurality of medical conversations, wherein the corpus of the medical-training dataset is created from one or more sources, wherein the one or more sources comprise of medical literature, textbooks, online databases, journal articles, graphics, podcasts, videos, animations and medical data warehouses, wherein the plurality of input forms comprise of at least one of text, image, audio, video, gif and animation.

3. The computer-implemented method as recited in claim 1, wherein the training of the virtual medical assistant system facilitates learning of the virtual medical assistant system, wherein the learning of the virtual medical assistant system, further comprises of:
crawling the corpus of the medical-training dataset to obtain the plurality of dialogue conversations from the corpus of the medical-training dataset;
manual annotation of questions based on a plurality of criteria, wherein the plurality of criteria comprises of user feedback, new content sources and popular questions, wherein the manual annotation of questions is followed by binary annotation of the plurality of dialogue conversations; and
building automatic classifiers for prioritizing the plurality of dialogue conversations, wherein the automatic classifiers are build using a plurality of hardware-run machine learning algorithms, wherein the plurality of hardware-run machine learning algorithms comprise of Random Forest, Adaboost, Naive Bayes and Support Vector Machine algorithm.

4. The computer-implemented method as recited in claim 1, wherein the one or more medical protocols are guidelines from one or more recognized medical institutions to provide the medical assistance to the user.

5. The computer-implemented method as recited in claim 1, wherein the one or more methods used to create the word embedding comprise of recurrent neural networks, convolutional neural networks, word embedding layer, word2vec and glove algorithms.

6. The computer-implemented method as recited in claim 1, wherein the plurality of dialogue conversations are extracted from the corpus of the medical-training dataset using natural language processing algorithms and speech recognition algorithms.

7. The computer-implemented method as recited in claim 1, wherein the plurality of dialogue conversations extracted manually are prioritized based on a confidence score, wherein the confidence score determines amount of confidence in a plurality of answers for a plurality of questions in the plurality of dialogue conversations.

8. The computer-implemented method as recited in claim 1, wherein the bi-directional conversation is initialized with the virtual medical assistant system in the plurality of input forms, wherein the virtual medical assistant system retrieves the specific concept from the bi-directional conversation using natural language processing algorithms and speech recognition algorithms.

9. The computer-implemented method as recited in claim 1, wherein the virtual medical assistant system tokenizes the context and utterances present in the word embeddings of words created from the corpus of the medical-training dataset and the word embedding of the retrieved specific concept from the enquired question, wherein the virtual medical assistant system tokenizes the context and utterances to insert special delineation tokens between the context and utterances to distinguish between the virtual medical assistant system and the user.

10. The computer-implemented method as recited in claim 1, wherein the mapping of the word embedding of the retrieved specific concept from the enquired question with the word embedding of words created from the corpus of the medical-training dataset, further comprises:
mapping the enquired question from the user with questions present in the plurality of dialogue conversations based on the context of the bi-directional conversation using unsupervised deep learning algorithms; and
mapping the enquired question from the user with answers present in the plurality of dialogue conversations based on the context of the bi-directional conversation using supervised deep learning algorithms.

11. The computer-implemented method as recited in claim 1, wherein the plurality of output forms comprise of at least one of text, image, audio, video, gif and animation.

12. The computer-implemented method as recited in claim 1, wherein the virtual medical assistant system is trained using embedding functions, wherein the virtual medical assistant system utilizes embedding functions for embedding context pairs, wherein the virtual medical assistant system utilizes embedding functions for embedding and utterance pairs.

13. The computer-implemented method as recited in claim 1, wherein the virtual medical assistant system determines medical issue faced by the user, wherein the virtual medical assistant system determines the medical issue by checking for symptoms of diseases by retrieval of the specific concept from the bi-directional conversation initialized between the user and the virtual medical assistant system.

14. The computer-implemented method as recited in claim 1, wherein the virtual medical assistant system determines health status of the user, wherein the virtual medical assistant system determines the health status of the user based on one or more health related devices connected with the virtual medical assistant system, wherein the virtual medical assistant system determines the health status of the user based on interaction history of the user with the virtual medical assistant system.

15. The computer-implemented method as recited in claim 14, wherein the virtual medical assistant system is connected with the one or more health related devices associated with the user, wherein the virtual medical assistant system fetches a set of data associated with the health status of the user from the one or more connected health related devices, wherein the set of data fetched is stored in the health profile associated with the user.

16. A computer system comprising:
one or more processors; and
a memory coupled to the one or more processors, the memory for storing instructions which, when executed by the one or more processors, cause the one or more processors to perform a method for enabling an interactive dialogue session between a user and a virtual medical assistant system, wherein the interactive dialogue session is enabled for providing medical assistance to the user, the method comprising:
training the virtual medical assistant system with a corpus of medical-training dataset, wherein the virtual medical assistant system is trained based on one or more medical protocols, wherein the virtual medical assistant system is trained with the corpus of the medical-training dataset in a plurality of input forms, wherein the training of the virtual medical assistant system comprises:
creating word embedding of words present in the corpus of the medical-training dataset in a low dimensional vector space, wherein the word embedding of words is created using one or more methods;
extracting a plurality of dialogue conversations from the corpus of the medical-training dataset based on the created word embedding, wherein the plurality of dialogue conversations are conversations between a plurality of users and a plurality of professional medical practitioners;
prioritizing the plurality of extracted dialogue conversations based on the one or more medical protocols, wherein the prioritization is done to train the virtual medical assistant system to learn an appropriate utterance to respond to the user from the corpus of the medical-training dataset;
initializing a bi-directional conversation between the virtual medical assistant system and the user through a computing device in real-time, wherein the bi-directional conversation is initialized by enquiring a question by the user or the virtual medical assistant system, wherein the bi-directional conversation is initialized to facilitate the virtual medical assistant system to provide the medical assistance to the user;
initializing a concept identification module to parse text present in the bi-directional conversation and retrieve specific concept from the bi-directional conversation, wherein the concept identification module is initialized to identify context of the bi-directional conversation, wherein the concept identification module is initialized to determine if the specific concept match with the one or more medical protocols, wherein the retrieved specific concept is represented as word embedding in the low dimensional vector space representation by the virtual medical assistant system;
mapping the word embedding of the retrieved specific concept from the enquired question with the word embedding of words created from the corpus of the medical-training dataset, wherein the mapping is done to determine the appropriate utterance as response to the enquired question in the context of the bi-directional conversation, wherein the context is concatenation of the enquired question as well as past utterances by the user and the virtual medical assistant system, wherein the mapping is done to determine the appropriate utterance as response even when the word embedding of the retrieved specific concept from the enquired question is not present in the word embedding of words created from the corpus of the medical-training dataset using deep learning, wherein the appropriate utterance as response is determined with an associated confidence level, wherein the mapping is done based on a plurality of deep learning algorithms and neural network models;
interactively replying by the virtual medical assistant system to the enquired question by the user with the determined appropriate utterance as response with the associated confidence level, wherein the virtual medical assistant system interactively replies to the enquired question in a plurality of output forms; and
updating a health profile of the user and the corpus of the medical-training dataset in real-time using recurrent neural networks, wherein the updating is done based on the enquired question from the user that are not present in the word embedding of words created from the corpus of the medical-training dataset,
wherein the bi-directional conversation is continued until the user is provided the complete medical assistance by the virtual medical assistant system.

17. The computer system as recited in claim 16, wherein the corpus of the medical-training dataset comprises of a plurality of question-answer pairs, a plurality of medical questions, a plurality of medical articles and a plurality of medical conversations, wherein the corpus of the medical-training dataset is created from medical literature, textbooks, online databases, journal articles, graphics, podcasts, videos, animations and medical data warehouses, wherein the plurality of input forms comprise of at least one of text, image, audio, video, gif and animation.

18. The computer system as recited in claim 16, wherein the training of the virtual medical assistant system facilitates learning of the virtual medical assistant system, wherein the learning of the virtual medical assistant system, further comprises of:
crawling the corpus of the medical-training dataset to obtain the plurality of the dialogue conversations from the corpus of the medical-training dataset;
manual annotation of questions based on a plurality of criteria, wherein the plurality of criteria comprises of user feedback, new content sources and popular questions, wherein the manual annotation of questions is followed by binary annotation of the plurality of dialogue conversations; and
building automatic classifiers for prioritizing the plurality of dialogue conversations, wherein the automatic classifiers are build using a plurality of hardware-run machine learning algorithms, wherein the plurality of hardware-run machine learning algorithms comprise of Random Forest, Adaboost, Naive Bayes and Support Vector Machine algorithm.

19. The computer system as recited in claim 16, wherein the mapping of the word embedding of the retrieved specific concept from the enquired question with the word embedding of words created from the corpus of the medical-training dataset, further comprises:
mapping the enquired question from the user with questions present in the plurality of dialogue conversations based on the context of the bi-directional conversation using unsupervised deep learning algorithms; and
mapping the enquired question from the user with answers present in the plurality of dialogue conversations based on the context of the bi-directional conversation using supervised deep learning algorithms.

20. A non-transitory computer-readable storage medium encoding computer executable instructions that, when executed by at least one processor, performs a method for enabling an interactive dialogue session between a user and a virtual medical assistant system, wherein the interactive dialogue session is enabled for providing medical assistance to the user, the method comprising:
training the virtual medical assistant system with a corpus of medical-training dataset, wherein the virtual medical assistant system is trained based on one or more medical protocols, wherein the virtual medical assistant system is trained with the corpus of the medical-training dataset in a plurality of input forms, wherein the training of the virtual medical assistant system comprises:
creating word embedding of words present in the corpus of the medical-training dataset in a low dimensional vector space, wherein the word embedding of words is created using one or more methods;
extracting a plurality of dialogue conversations from the corpus of the medical-training dataset based on the created word embedding, wherein the plurality of dialogue conversations are conversations between a plurality of users and a plurality of professional medical practitioners;
prioritizing the plurality of extracted dialogue conversations based on the one or more medical protocols, wherein the prioritization is done to train the virtual medical assistant system to learn an appropriate utterance to respond to the user from the corpus of the medical-training dataset;
initializing a bi-directional conversation between the virtual medical assistant system and the user through a computing device in real-time, wherein the bi-directional conversation is initialized by enquiring a question by the user or the virtual medical assistant system, wherein the bi-directional conversation is initialized to facilitate the virtual medical assistant system to provide the medical assistance to the user;
initializing a concept identification module to parse text present in the bi-directional conversation and retrieve specific concept from the bi-directional conversation, wherein the concept identification module is initialized to identify context of the bi-directional conversation, wherein the concept identification module is initialized to determine if the specific concept match with the one or more medical protocols, wherein the retrieved specific concept is represented as word embedding in the low dimensional vector space representation by the virtual medical assistant system;
mapping the word embedding of the retrieved specific concept from the enquired question with the word embedding of words created from the corpus of the medical-training dataset, wherein the mapping is done to determine the appropriate utterance as response to the enquired question in the context of the bi-directional conversation, wherein the context is concatenation of the enquired question as well as past utterances by the user and the virtual medical assistant system, wherein the mapping is done to determine the appropriate utterance as response even when the word embedding of the retrieved specific concept from the enquired question is not present in the word embedding of words created from the corpus of the medical-training dataset using deep learning, wherein the appropriate utterance as response is determined with an associated confidence level, wherein the mapping is done based on a plurality of deep learning algorithms and neural network models;
interactively replying by the virtual medical assistant system to the enquired question by the user with the determined appropriate utterance as response with the associated confidence level, wherein the virtual medical assistant system interactively replies to the enquired question in a plurality of output forms; and
updating a health profile of the user and the corpus of the medical-training dataset in real-time using recurrent neural networks, wherein the updating is done based on the enquired question from the user that are not present in the word embedding of words created from the corpus of the medical-training dataset,
wherein the bi-directional conversation is continued until the user is provided the complete medical assistance by the virtual medical assistant system.
